(19) United States
(12) Patent Application Publication
(10) Pub. No.: US 2009/0109173 A1
(43) Pub. Date: Apr. 30, 2009

(54) Multi-function computer pointing device

(76) Inventor: Liang Fu, Potomac, MD (US)

Correspondence Address: LIANG FU, 12046 GATEWATER DRIVE, POTOMAC, MD, 20854, US

(21) Appl. No.: 11/926,048

(22) Filed: Oct. 28, 2007

(51) Int. Cl. G09G 5/00

(52) U.S. Cl. 345/156

(57) ABSTRACT

A first aspect of the present invention includes an N-persistent-mode pointing device and a 2N-mixed-mode pointing device. A second aspect of the present invention is an unconventional method for generating target-motion signals with common motion controls. This method utilizes a qualification-rule-based dynamic mapping of the present invention. A third aspect of the present invention combines the multi-mode designs and the dynamic mapping.

### CROSS-REFERENCE TO RELATED APPLICATIONS

Not Applicable

### FEDERALY SPONSORED RESEARCH

Not Applicable

### SEQUENCE LISTING OR PROGRAM

Not Applicable

### BACKGROUND OF THE INVENTION

1. Field of Invention

This invention relates to pointing devices, especially multi-dimensional and multi-function pointing devices.

2. Prior Art

Pointing device and Graphical User Interface (GUI) provide convenient interface for people to interact with computers and other types of equipment. The most popular pointing devices include mouse, trackball, touch pad, and joystick (or the like). Pointing devices often comprise two types of user operable controls, namely, button control and motion control. A Button control detects the activation and deactivation (e.g., press and release) caused by user and generates simple on and off button-control signals accordingly. A button control may comprise a simple mechanical switch or one or more sensors. A motion control detects certain type(s) of motion caused by the user and generates motion-control signals accordingly.

A mouse has a mouse motion control underneath the mouse, which detects the two-dimensional (2D) movement of the mouse and generates 2D motion-control signals reflecting the 2D movement. A trackball detects the 2D rotation of the trackball and generates 2D motion-control signals reflecting the 2D rotation. A scroll wheel detects the one-dimensional (1D) rotation of the scroll wheel and generates 1D motion-control signals reflecting the 1D rotation. A touch pad detects the 2D motion of the user's finger and generates 2D motion-control signals reflecting the 2D motion. A joystick detects the direction and magnitude of the force applied by user and generates 2D motion-control signals reflecting the applied force.

A pointing device further comprises (1) a main circuit often including a microcontroller, which processes the button-control and motion-control signals and formats them into button-control and motion-control data, and (2) a communication link (cable or wireless) that communicates with the computer or equipment, sending control signals (data) to and even receiving signals (data) from the computer or equipment.

Each control usually has a specific function. The button-control signals (or data) are often used to select an object on the GUI or start/execute a program or application. The motion-control signals (or data) are often used to control certain types of motion function, such as cursor movement, object movement and rotation, document scroll, etc. There are many other types of functions that can be controlled by motion controls, such as panning or zooming images, adjusting brightness, contrast and color of a screen display, adjusting sound volume, etc. Although some of these functions do not involve “motion” in strict sense, they will all be considered as motion functions for consistent descriptions. The two types of controls may also work together to perform desired combination functions. For example, a user uses a motion control to move the cursor to a specific position (over an object) and uses a button control to select the object (icon) or start the program/application associated with the object. The user can also drag an object by pressing and holding a button control and moving the motion control.

Because pointing devices are easy to use, many computer programs have been developed to allow users to interact in a variety of ways using pointing device. Many other types of equipment (which essentially comprise special-purpose computer) have also been designed to work with pointing devices in a variety of ways. This trend is likely to continue for the foreseeable future.

A basic-type pointing device has one motion control and two button controls. For more complex and sophisticated interactions, a basic-type pointing device may be inconvenient or inadequate. For example, current word processing and spreadsheet programs have scroll capability. With a basic-type pointing device, a user has to click the horizontal or vertical scroll buttons or drag the corresponding handles to scroll through a document. To simplify the scroll process, scroll wheel has been added to the basic-type pointing devices. At present, most mice have one scroll wheel for vertical scroll. Some pointing devices have two scroll wheels, one for vertical scroll and the other for horizontal scroll. Others have a tiltable scroll-wheel (the rotation causes vertical scroll and the tilting causes horizontal scroll) or a scroll ball (similar to a trackball but for scroll control).

Another example of multi-function control is that some Computer Aided Design (CAD) programs and graphics programs are capable of creating and manipulating 3D representations of solid objects. Since six degrees of freedom are needed to completely determine the position and orientation of a solid object, it would be desirable for such applications that a pointing device is capable of controlling all those six degrees of freedom.

In response to these increasing demands, many multi-dimensional and multi-function pointing devices have been invented. Since a dimension control can also be considered a function, for simplicity and consistency the term “function” will be used for both. Likewise, any pointing device with any functionality or capability beyond those of a basic-type pointing device will be referred to as a multi-function pointing device. The prior art approaches to the multi-function pointing devices can be divided into three groups according to the fundamental concepts that they are based.

The first prior art approach to the multi-function pointing devices is basically inspired by the concept of scroll wheel. That is, adding additional controls for additional functions. In this group of multi-function pointing devices, each control is dedicated for a specific function. These designs will be called single-mode designs since these pointing devices only have one mode and each control has only one designated function.

Single-mode designs suffer from the following disadvantages.
(A1) Functions require their own controls, thus limiting the total number of functions.
(A2) Controls and functions are tied together, hence, the pointing devices are not versatile.
(A3) The complexity and components increase dramatically with the increase of functions, hence, reliability is predictably low, and the manufacturing cost is predictably high.
(A4) The pointing devices become too bulky and heavy.
(A5) The signal-processing channels and the signal-processing load increase dramatically with the increase of functions.
(A6) Expanding the capability (adding functions) is difficult and has significant impact on other components, to the point of requiring a complete redesign of the system.
(A7) The exterior of the pointing device is complex and crowded, thus becoming ergonomically deficient.
(A8) A pointing device with large number of controls is confusing to most users and difficult to use in any case.
(A9) Various controls compete for positions, and some of them must be put in places that are relatively difficult to reach or operate.
(A10) User has to avoid other controls while operating a control.
(A11) User has to move their hands and change hand postures when switching from one control to another.
(A12) Different controls require different operation types (sliding, rotating, turning, tilting, etc.), thus users are forced to switch from one type to another.

The second prior art approach to the multi-function pointing devices uses a motion control for two motion functions. These multi-function pointing devices have two modes. The motion control controls one motion function in one mode and another motion function in the other mode. For example, in one mode the motion control controls cursor movement and in the other mode it controls document scroll. These designs will be called dual-mode designs. The examples of this group include the TrackPoint, U.S. Pat. Nos. 5,446,481, 5,530,455, 5,784,052, 6,313,849, 7,193,612, 7,168,047, and 7,142,193, and U.S. patent applications Ser. Nos. 11/635,760, 09/045,463 and 09/818,386.

A common disadvantage of these dual-mode designs is that one of the two modes is a momentary mode, and accessing the momentary mode requires a user to press and hold a momentary switch. The only difference among these dual-mode designs is the type and/or position of the momentary switch. TrackPoint uses a dedicated button on the keyboard, witch is essentially a momentary switch. U.S Pat. No. 6,313,849 and Ser No. 09/045,463 use a special function key on the keyboard (e.g., shift or Ctrl key, which are essentially momentary switches). U.S. Pat. Nos. 5,446,481, 5,530,455, and 7,193,612 use a momentary mechanical switch underneath a scroll wheel. U.S. Pat No. 5,784,052 uses a momentary switch underneath a trackball. U.S. Pat. No. 7,142,193 uses a momentary switch underneath a wheel with rotating bodies. U.S. Pat. No. 7,168,074 and Ser. No. 11/635,760 use one or more momentary optical switches on the side of the mouse. Ser. No. 09/818,386 uses a momentary mechanical switch on the side of the mouse.

The dual-mode designs have the following common disadvantages.
(B1) They require an additional momentary switch (mechanical or optical switch).
(B2) They are limited to two modes and leave no possibility for expansion,
(B3) Only one motion control performs double duty (controls two functions), while other controls still perform single duty.
(B4) One of the two modes is a momentary mode where a user has to press and hold the momentary switch while operating the motion control, which is difficult and undesirable. In particular, U.S. Pat. No. 6,313,846 and Ser. No. 09/045,463 basically requires two-hand operation, U.S. Pat. Nos. 5,446,481, 5,530,455, 5,784,052 and 7,142,193 require the user to depress and hold down the wheel (trackball, or wheel with rotating bodies) while simultaneously rotate it, which is extremely awkward and difficult. This is the most severe disadvantage for the prior art dual-mode designs.

There are other prior art designs that are essentially based on the same idea as the dual-mode designs (i.e., one motion control for two functions) but with some variations. U.S. Pat. Nos. 5,633,657, 5,374,942, and 5,313,229 disclose a mouse with a scroll function based on a dominant axis analysis method. In these designs, a scroll button (U.S. Pat. No. 5,633,657) or a thumb lever (U.S. Pat. Nos. 5,374,942 and 5,313,229) generates the scroll rate signals, while the mouse movement signals are analyzed to determine the dominant axis for scroll direction. So the mouse motion control does more than just controlling the cursor motion, although it does not provide complete scroll control.

Strictly speaking, these designs are not dual-mode designs since they do not involve mode change and the mouse motion control controls cursor motion and scroll direction simultaneously. However, these designs incorporate most of the disadvantages of the dual-mode designs and have further disadvantages. The dominant-axis method has a severe functional problem, namely, the scroll occurs only along one axis (the dominant axis) at any step. When a user moves the mouse along a diagonal path, the actual scroll is either vertical or horizontal, depending on which axis the mouse has the relatively greater movement. In attempt to scroll diagonally, a user has to constantly move the mouse in a zigzagged fashion in order to alternate the dominant axis, and the resultant scroll is at best of a zigzagged type. In practical use, a user constantly feels that the scroll is incongruous with the movement of the mouse. Furthermore, users have to operate both the motion control and the scroll-rate control (thumb lever or scroll button) simultaneously.

In summary, these dominant-axis designs have the following additional disadvantages.
(C1) An extra scroll-rate control (scroll button, thumb lever) is required in addition to mouse motion control to provide scroll rate signals.
(C2) User has to operate both the scroll-rate control (scroll button or thumb lever) and the mouse motion control simultaneously.
(C3) Scroll can only occur in one dimension at a time.
(C4) The direction of mouse motion and that of scroll are often incongruous.
(C5) The cursor also moves when the scroll direction is being altered, which may be confusing and undesirable.

The third prior art approach to the multi-function pointing devices is represented by U.S. patent application Ser. No. 10/636,745. This approach allows practically any desired number of modes and functions. These designs will be referred as the N-mode designs. In each mode, every control (button control, motion control), rather than only one of them (as in the dual-mode designs), may be mapped to a suitable function. Ser. No. 10/636,745 teaches three methods to achieve multi-function control, each with a different type of mode-selection means.

The first method of Ser. No. 10/636,745 uses a dedicated persistent mode-selection means, and all modes are persistent.

The second method of Ser. No. 10/636,745 uses at least one of the existing controls (button control and/or motion control) to double as the mode-selection means (in addition to its usual function). With this method, a unique sequence of the signals from the existing control(s) that double as mode-selection means indicates a specific mode. Either a button control or motion control or any combination of the controls can double as mode-selection means, in addition to their normal functions. The modes of this method may be either persistent or momentary. In either case, this method uses no dedicated hardware mode-selection means.

The third method of Ser. No. 10/636,745 uses a mode-selection menu on a display as the mode-selection means. A user clicks an item from the mode-selection menu to select a mode. The modes of this method are all persistent. Again, this method requires no dedicated hardware mode-selection means.

Another common and major problem of the prior art pointing devices is that the conventional implementations of motion controls are often not optimal, at least for some motion functions. One example is the scroll wheel. Although scroll wheel is very popular in pointing devices, it is not very effective and efficient.

The scroll wheel has the following disadvantages.
(D1) User has to repeatedly turn the scroll wheel in order to keep the scroll going, which is very tedious.
(D2) User has to reposition the finger after each turn, which not only is tedious but also makes the scroll intermittent.
(D3) It is basically only suitable for small amount and occasional scrolls, and user still has to use scroll bar for large amount scroll.
(D4) The gain (ratio between scroll amount and wheel turning) cannot satisfy all scroll needs.
(D5) Changing the gain requires several steps hence most users never change it.

For clarity and definiteness, “user input” will be used to describe a measurable quantity produced by a motion control that reflects the user operation (e.g., moving a mouse, rotating a scroll wheel or trackball, finger sliding on touch pad, etc.), and “target motion” will be used to describe the response of the motion functions (e.g., motion of the cursor, number of pixels/lines scrolled, change of brightness, sound volume, etc.).

Computer and pointing device work in cycles, in each cycle the motion control reports (or is polled for) the user input of the cycle. Conventional implementations use same-cycle static mappings, where the target motion of each cycle maps to the user input of the same cycle. Since the computer system in general is not a real-time system, the terms, such as “same cycle”, should be interpreted loosely (factor in the latency). An intrinsic property of the static mapping is that the target motion ceases when the user inputs cease. This intrinsic property is a major source for the deficiency of the conventional implementations.

The common motion controls used in the pointing devices can be divided into two general groups, namely, isotonic motion controls and isometric motion controls. Isotonic motion controls, including mouse motion control, trackball, scroll wheel, and touch pad, do not have a natural center position. In each cycle, an isotonic motion control reports (or is polled for) the incremental user input of the cycle. Conventional implementations of isotonic motion controls map the incremental user input to an incremental target motion of the same cycle:

Δ\vec{T}ᵢ=\vec{ƒ}(Δ\vec{I}ᵢ) (equation 1)

where Δ\vec{I}ᵢ and Δ\vec{T}ᵢ are, respectively, the incremental user input and the corresponding incremental target motion of the current cycle, \vec{ƒ}( ) is the transformation function with ƒ(0)=0, and the subscript I indicates the current cycle.

The ratio between the target motion and user input is often called gain. A linear transformation function corresponds to a constant gain. A constant gain often cannot provide satisfactory motion control in all situations, since a small gain is needed for fine target motion while a large gain is needed fast target motion. Hence, with a constant gain, a user often finds the response is too slow or too fast.

Nonlinear transformation functions correspond to variable gain, which are often referred as accelerated gains. For example, U.S. Pat. Nos. 6,865,718 and 7,170,491, and U.S. patent application Ser. No. 11/002,590 teach an accelerate method with a three-level transformation function depending on the magnitude of the user input. U.S. Pat. Nos. 6,738,045 and 7,277,084 teach an accelerated method with a continuous transformation function (acceleration curves). U.S. Pat. No. 7,071,919, U.S. patent applications Ser. Nos. 11/249,501 and 11/249,568 teach an accelerated method with a three-level transformation function that depends on both the displacement and the rate of the user input. Although these accelerated gains improve upon constant gain, they retain the intrinsic property of the static mappings, namely, the target motion ceases when the user inputs cease. Therefore, these accelerated methods do not overcome most of the disadvantages of the static mappings.

An isometric motion control, such as isometric joystick or TrackPoint, reports (or is polled for) its current state, often in the form of the force (torque, pressure, etc.) that a user applies, in each cycle. Isometric motion controls do have a natural center position and automatically return to it when the applied force vanishes. Conventional implementations of isometric motion controls map the applied force (user input) to the velocity of target motion of the same cycle:

$$\frac{d {\vec{T}}_{i}}{d t} = \vec{f} ( {\vec{F}}_{i} ) \qquad ( equation 2 )$$

where \vec{F}ᵢ and d\vec{T}ᵢ/dt are, respectively, the applied force (user input) and the velocity of the target motion, \vec{ƒ}( ) is the transformation function with ƒ(0)=0. Since isometric motion controls in general have limited operation range, a small gain makes them ineffective, but a large gain often makes them too sensitive. Accelerated gain improves upon constant gain but cannot provide satisfactory target motion in many situations.

It is worth emphasizing that, as indicated by the subscript i in equations 1 and 2, the target motion of each cycle always maps to the user input of the same cycle. This is a particular case of static mapping, namely, the same-cycle static mapping. In general, static mapping between two time sequences, namely, a source sequence (x₁,x₂,x₃, . . . xᵢ) and a target sequence (y₁,y₂,y₃, . . .yᵢ), can be written as

yᵢ=ƒ(xᵢ₋ₖ₁,xᵢ₋ₖ₂,xᵢ₋ₖ₃, . . . xᵢ₋ₖₙ) (equation 3)

where n,k₁,k₂,k₃. . . kₙ are all fixed integers. So in a general static mapping, a member of the target sequence may depend on several members (of current cycle and previous cycles) of the source sequence. However, the number of the source-sequence members (the integer n in equation 3) that a target-sequence member depends on, the time positions of these source-sequence members relative to that of the target-sequence member (determined by the integers k₁,k₂,k₃, . . . kₙ in equation 3), and the transformation function ƒ( ) are all predetermined and never change. The same-cycle static mappings described by equations 1 and 2 are particular cases of equation 3 with n=1 and k₁=0. Even with general static mapping as defined by equation 3, the target motion will cease eventually when the user inputs cease.

Static mapping imposes severe limitations, which compound with the intrinsic limitations of isotonic and isometric motion controls. With static mapping, continuous target motion requires continuous user input, which translates to continuous user operation. Steady target motion requires steady user input, which translates to steady user operation. Maintaining a steady target motion is difficult for either type of controls, since isotonic motion controls are hindered by limited working space while isometric motion controls are hindered by their high sensitivity. For isotonic motion controls, large amount of target motion requires large operation space and/or repeated repositions (e.g., picking up and moving a mouse for next motion, lifting and moving finger for next wheel rotation, etc.). And fast target motion requires fast user input, which translates to fast user operation. This is true even if accelerated gain is used, since as soon the user slows down, the gain reduces and the target motion slows down more dramatically. On the other hand, for isometric motion controls, continuous target motion requires continuous applied force, and steady target motion requires steady applied force. Steady target motion is proven to be quite difficult to maintain, jittering or fluctuated result is common.

In summary, regardless of whether or what acceleration method is used, the conventional implementations of isotonic motion controls have the following disadvantages.
(E1) Large target motion requires large working space and/or repeated repositions.
(E2) Continuous target motion requires continuous user operation.
(E3) Fast target motion requires fast user operation.
(E4) Steady target motion is difficult to maintain due to limited working space and/or repositions.

Similarly, regardless of whether or what acceleration method is used, the conventional implementations of isometric motion controls have the following disadvantages.
(F1) The isometric motion controls are often ineffective or too sensitive due to limited operation range.
(F2) Accurate target motion is difficult to obtain.
(F3) Continuous target motion requires continuous applied force.
(F4) Steady target motion is difficult to maintain due to high sensitivity, and jittering or fluctuated result is common.

Although the prior art multi-mode designs (dual-mode designs and N-mode designs) are advantageous than the single-mode designs, there is room for improvement. The challenge for multi-mode designs is to solve the problem of incompatible motion functions. Different motion functions may have very different or even conflicting requirements. For example, accuracy is often more important for cursor motion, while large amount/fast motion is often more important for document scroll. On the other hand, each particular motion control may be only suitable for a particular type of motion function. Generally speaking, with static mappings, isotonic motion controls are suitable for accurate and small amount/slow target motions, while isometric motion controls are suitable for large amount/fast and coarse target motions. Hence, if one motion control of either type were used to control two or more incompatible motion functions, at least some of these motion functions would not be controlled effectively and/or efficiently. In fact, many of the dual-mode designs suggest using the same motion control for both cursor motion and document scroll. It is predictable that these dual-mode designs will not provide satisfactory control for both cursor motion and document scroll.

In summary, there is a need for a multi-function pointing device with effective and efficient motion controls to overcome the aforementioned disadvantages of prior-art designs.

### BACKGROUND OF INVENTION—OBJECTIVES AND ADVANTAGES

The present invention has three aspects. The major objectives and advantages of the first aspect of the present invention are:
1. to provide a general and unified method of multi-function control that is versatile and efficient, requires fewer components, can easily support a large number of functions, and allows easy expansion of capability;
2. to provide a general and unified method of multi-function control that can be applied practically to any prior-art basic-type or multi-function pointing device, to increase its capability, simplify its structure, reduce its signal processing load, and improve its usability;
3. to provide a multi-function pointing device that provides accurate and large-range control consistently for all functions;
4. to provide a multi-function pointing device that has a simple exterior without crowded controls, hence leaving more room to ergonomic and other considerations;
5. to provide a multi-function pointing device that has a simpler internal structure and uses fewer parts, hence, is more reliable and less expensive to produce;
6. to provide a multi-function pointing device that requires less signal processing and data transmission, hence, is more efficient;
7. to provide a multi-function pointing device that is intuitive and easy to use;
8. to provide a multi-function pointing device that allows users to control all functions in a unified simple manner;
9. to provide a multi-function pointing device that allows users to maintain an optimal hand posture and position at all times;
10. to provide a multi-function pointing device that is programmable and allows a user to select and group the functions according to individual needs.

The major objectives and advantages of the second aspect of the present invention are:
11. to provide a method for motion function control that substantially reduces user operations.
12. to provide a method for motion function control that substantially reduces repositions.
13. to provide a method for motion function control that works effectively and efficiently.
14. to provide a method for motion function control that is suitable in all situations that the users may encounter.
15. to provide a method for dynamic motion function control where the user can control all aspects of the target motion by the same motion control.
16. to provide a method for dynamic motion function control where the user can easily adjust all major aspects of the target motion on the fly.

The major objectives and advantages of the third aspect of the present invention are:
17. to provide a method for multi-function control that allows one motion control to control incompatible motion functions as well as compatible ones.
18. to provide a method for multi-function control that allows each pair of motion control and motion function to use the optimal mapping.
19. to provide a method for multi-function control where each motion function is controlled most effectively and efficiently.

Further advantages will become apparent from the following descriptions and drawings.

### SUMMARY

The present invention has three aspects. The first aspect of the present invention includes an N-persistent-mode pointing device and a 2N-mixed-mode pointing device. The N-persistent-mode pointing device has N persistent modes and uses a simple momentary switch as the hardware component of the mode-selection means. The N-persistent-mode design of the present invention requires essentially the same number/type of hardware components as the prior art dual-mode designs but may have practically any desired number of modes and control practically any desired number of functions. As explained later, the N-persistent mode design of the present invention overcomes all disadvantages of the prior art single-mode designs, dual-mode designs, dominant-axis designs, and host-implemented methods. The 2N-mixed-mode design further expands the total modes to 2N and provides more flexibilities and possibilities. With essentially the same number/type of hardware components as the prior art dual-mode designs, the N-persistent-mode and 2N-mixed mode designs can practically any desired number of functions.

The second aspect of the present invention is an unconventional method for generating target-motion signals with common motion controls used in pointing devices. In contrast to conventional implementations, the present invention uses a qualification-rule-based dynamic mapping. The second aspect of the present invention provides more effective and efficient target motion control with the same hardware motion controls. As explained later, the qualification-rule-based dynamic mapping of the present invention overcomes all the disadvantages of the prior art static and dynamic mappings.

The third aspect of the present invention combines the multi-mode designs with the qualification-rule-based dynamic mapping of the second aspect of the present invention, taking their separate advantages and further generating combined advantages. This aspect of the present invention allows using different mappings for different motion control and motion function pairs, hence solves the problem of incompatible motion functions. The final result is an N-persistent-mode or a 2N-mixed-mode pointing device that controls more functions, controls each function more effectively and efficiently, and/or requires fewer components. As explained later, the third aspect of the present invention overcomes all disadvantages of the prior art multi-function pointing devices.

### DRAWINGS—FIGURES

In the drawings, closely related figures have the same number but different alphabetic suffixes.

FIG. 1A shows the N-persistent-mode correspondence (between the controls and the functions) used in the N-persistent-mode pointing device of the present invention.

FIG. 1B shows the schematic view of the N-persistent-mode pointing device of the present invention.

FIG. 1C shows the operation of the N-persistent-mode pointing device of the present invention.

FIG. 2A shows the 2N-mixed-mode correspondence (between the controls and the functions) used in the 2M-mixed-mode pointing device of the present invention.

FIG. 2B shows the schematic view of the 2N-mixed-mode pointing device of the present invention where a dedicated momentary switch is used as the mode-switch means.

FIG. 2C shows the schematic view of the 2N-mixed-mode pointing device of the present invention where the mode-selection means doubles as the mode-switch means.

FIG. 2D shows the schematic view of the 2N-mixed-mode pointing device of the present invention where a dedicated momentary switch doubles both the mode-selection means and the mode-switch means.

FIG. 2E shows the schematic view of the 2N-mixed-mode pointing device of the present invention where an existing button control doubles as the mode-switch means.

FIG. 2F shows the schematic view of the 2N-mixed-mode pointing device of the present invention where an existing button control doubles as both the mode-selection means and the mode-switch means.

FIG. 3 shows the operation of the QR-based dynamic mapping of the present invention.

FIG. 4A shows an elevated view of a trackball implemented with the QR-based dynamic mapping of the second aspect of the present invention.

FIG. 4B shows a top view of a trackball implemented with the QR-based dynamic mapping of the present invention.

FIG. 4C shows a sectional view of a trackball with a physical center implemented with the QR-based dynamic mapping of the present invention.

FIG. 5A shows the operation of a specific form of the QR-based dynamic mapping of the present invention.

FIG. 5B shows the operation of a specific form of the QR-based dynamic mapping of the present invention with specific start and stop controls.

FIG. 5C shows the operation of a specific form of the QR-based dynamic mapping of the present invention with specific start and stop controls, where the stop control is based on a different quantity.

FIG. 6 shows the operation of the general QR-based dynamic mapping of the present invention with general start and stop control (criteria).

FIG. 7 shows the operation of the QR-based dynamic mapping of the present invention with mapping-alteration protocol and control protocol.

FIG. 8A shows the required components for a two-mode design according to prior art multi-mode designs.

FIG. 8B shows the required components for a two-mode design according to the third aspect of the present invention.

FIG. 9A shows the operation of an exemplary embodiment of the third aspect of the present invention, where a dedicated mode-selection means is used.

FIG. 9B shows the operation of an exemplary embodiment of the third aspect of the present invention, where an existing button control doubles as the mode-selection means.

FIG. 9C shows the operation of an exemplary embodiment of the third aspect of the present invention, where an existing motion control doubles as the mode-selection means.

FIG. 9D shows the operation of an exemplary embodiment of the third aspect of the present invention, where an existing button control and an existing motion control jointly double as the mode-selection means.

FIG. 9E shows the operation of an exemplary embodiment of the third aspect of the present invention, where an existing button control doubles as both the mode-selection means and mode-switching means.

### DETAILED DESCRIPTION—PREFERRED EMBODIMENTS OF THE FIRST ASPECT OF THE PRESENT INVENTION

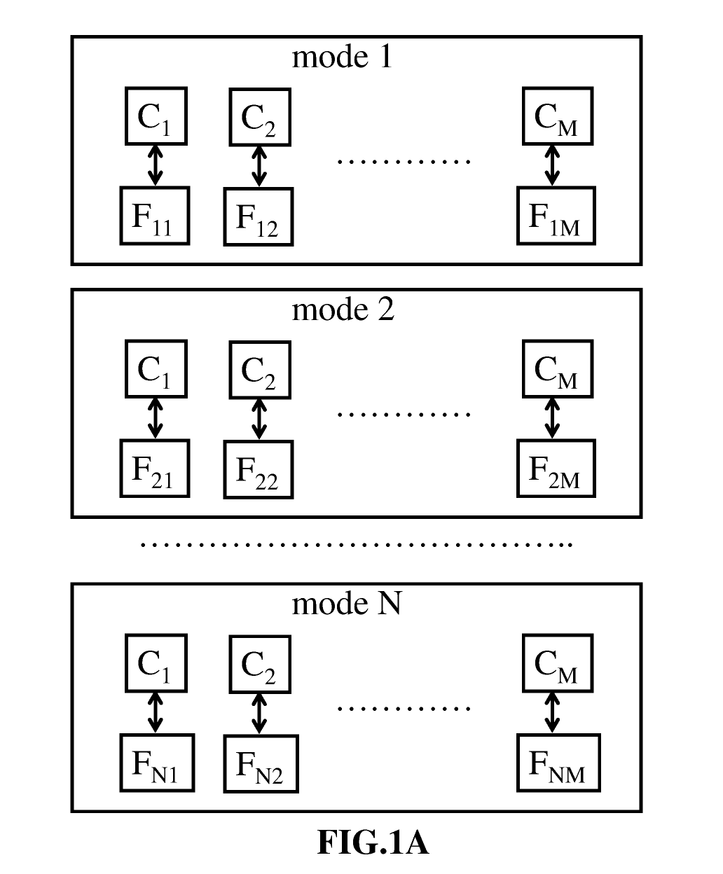

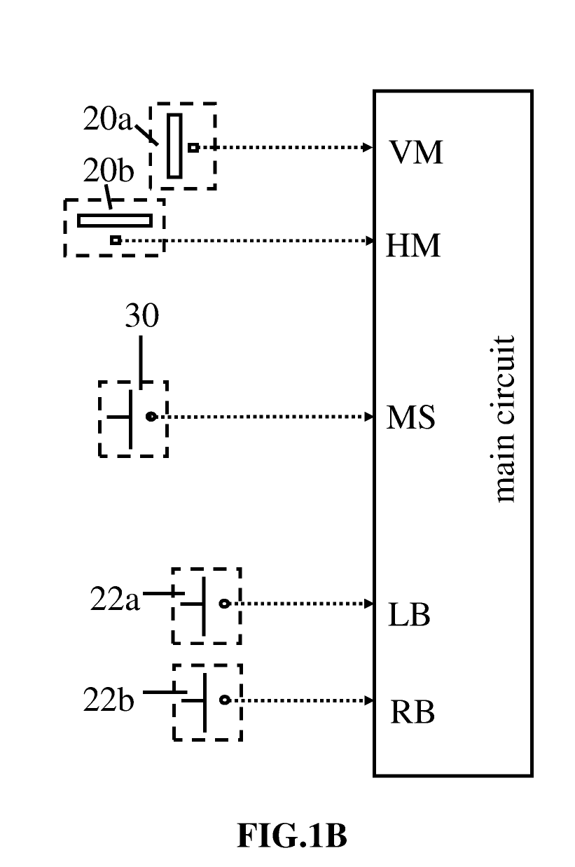

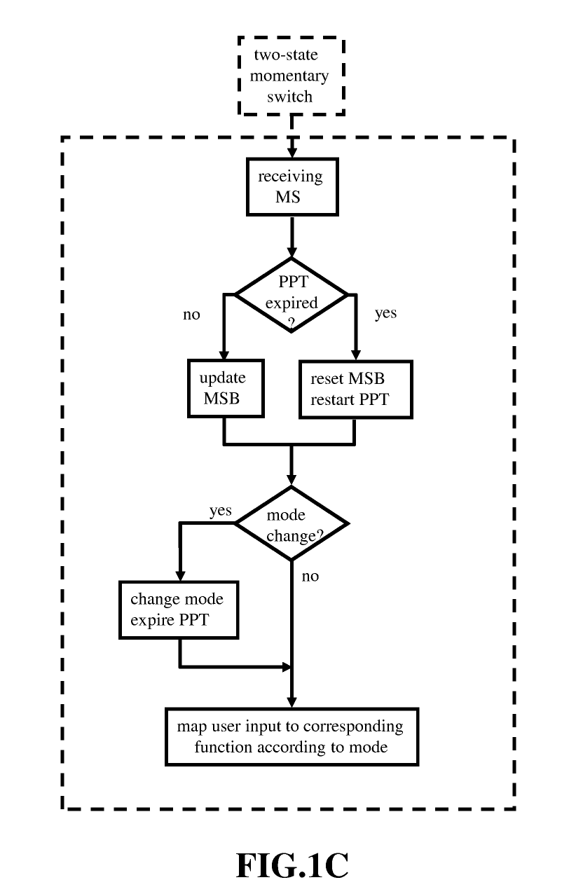

The first aspect of the present invention includes an N-persistent-mode pointing device and a 2N-mixed-mode pointing device. For the N-persistent-mode pointing device of the present invention, an N-persistent-mode correspondence is established where each control is assigned to control a specific (suitable) function in each persistent mode. FIG. 1A depicts the N-persistent-mode correspondence for M controls (C₁,C₂, . . . C_{M}) to control up to N×M functions (F₁₁,F₁₂, . . . F_{NM}). Some of these functions may be redundant or null functions (the corresponding control in the corresponding mode has no effect). Each double-headed arrow in FIG. 1A represents a specific mapping between a specific pair of control and function. With this arrangement, the N-persistent-mode pointing device of the present invention may control as many as N times functions as a single-mode design with same number/type of controls. Construction of an N-persistent-mode pointing device from a basic-type mouse will be used as example. From the following description, the skilled in the art should appreciate that the N-persistent-mode design of the present invention can be applied to almost any basic-type pointing device, such as a mouse, a trackball, a touch pad, a joystick, a sensor tablet, etc.

Refer to FIG. 1B for the schematic view of the N-persistent-mode pointing device. This particular pointing device comprising (1) a 2D mouse motion control 20a and 20b, inputting to signal channels VM and HM, respectively; (2) two button controls 22a (left button) and 22b (right button), inputting to signal channels LB and RB, respectively; (3) a momentary switch 30, inputting to the signal channel MS; (4) a main circuit including a microcontroller and a communication link to the host. Although a mouse motion control is an integrated component that provides the 2D motion control simultaneously, it is considered as two separate 1D motion controls 20a and 20b for the sake of clarity. The two button controls 22a and 22b and the momentary switch 30 may comprise a simple mechanical switch or a sensor switch (optical, capacitive, strain gage, ultrasonic, electromagnetic, or any other suitable type), as long as it is capable of generating at least two distinct signals (e.g., on and off). This momentary switch 30 is the hardware component of the mode-selection means that allows a user to indicate a mode-selection request.

Although hardware-wise the N-persistent-mode pointing device as depicted in FIG. 1B may appear similar to the prior art dual-mode designs, it differs completely from the dual-mode designs. The N-persistent-mode design of the present invention can have practically any desired number of modes, and each mode is a persistent mode (user does not have to hold down the momentary switch). The difference is that all the dual-mode designs are based on the concept of momentary modes, while the present invention is based on the concept of persistent modes. All of the dual-mode designs map the two states of the momentary switch directly to two modes, so they switch to the second mode (momentary mode) when the momentary switch is activated and switch back to the first mode when it is deactivated (released). In contrast, the fundamental idea of the present invention is not to map the two states directly to two modes. Rather, the present invention uses a predetermined mode-selection protocol where a unique sequence of the signals generated by a user via the momentary switch (mode-selection means) during a predetermined period of time indicates a specific mode-selection request. The system switches to a selected mode according to the mode-selection request and stays in that mode until the next mode-selection request is received (persistent modes). In each mode, each control maps to a specific function according to the N-persistent-mode correspondence.

A simple example of the mode-selection protocol may use the number of activations of the mode-selection means to identify mode-selection requests. Difference number of activations within the predetermined period of time indicates different mode-selection request. For example, three consecutive activations/deactivations (i.e., a triple click) indicates mode-selection request number three.

Another example of the mode-selection protocol may use the time reference for identification of mode-selection request. For example, holding down the mode-selection means for one second, two seconds, etc. indicate different mode-selection requests. Preferably, the pointing device produces a feedback (e.g., a beep) for each time unit (e.g., second). For example, activating the mode-selection means for two seconds (two beeps) indicates mode-selection request number two.

More elaborate mode-selection protocols may use both number of activations and time reference. Alternating short and long activations can produce countless unique sequences. These mode-selection protocols work similar to Morse code, Baudot code, or ASCII code, but are much simpler since only a limited number of mode-selection requests is required.

A exemplary embodiment with sequential accessible modes arranges the N persistent modes in a circular order and uses a mode-selection protocol with only one unique sequence (can be as simple as activation and deactivation, i.e., a single click). This unique sequence indicates the mode-selection request for the next persistent mode in forward direction (e.g., clockwise). With this embodiment, the modes are sequentially accessible. In the case of N=2, the unique sequence toggles between the two persistent modes. Even for the case of N=2 the present invention differs from the prior art dual-mode designs since both of the two modes are persistent modes and neither of them requires a user to press and hold the momentary switch to stay in that mode. When the system starts (computer turns on, the pointing device plugs on, etc.) and in error conditions, a default persistent mode (e.g., mode number one) may be assumed. A second unique sequence (e.g., double click) may be used to switch the modes backwards (e.g., counterclockwise). More unique sequences may also be used with this embodiment to provide more possibilities than strict sequential mode change. For example, three consecutive clicks within the predetermined period of time indicate a mode-selection request for the third mode down the line.

A exemplary embodiment with random accessible modes arranges the N persistent modes in a predetermined order and uses a mode-selection protocol with N unique sequences, each indicating a specific mode. For example, five consecutive clicks within the predetermined period of time indicate the mode-selection request for the fifth mode. In this case each mode-selection request directly indicates the persistent mode to change to. This embodiment allows a user to randomly access any desired persistent mode. Again, a default persistent mode may be assumed at system start or in any error condition.

The skilled in the art should appreciate that there are countless choices of mode-selection protocols and they cannot be listed or described one by one. No matter what mode-selection protocol is used and whether the sequential or random access scheme is adopted, the present invention allows practically any desired number of modes and every mode is a persistent mode.

FIG. 1C shows the operation of the N-persistent-mode pointing device of the present invention. Upon receiving signal from MS channel (the on or off signals from the momentary switch), the system checks if the predetermined period of time (PPT) has expired. If so, the system resets the mode-selection buffer (MSB) with the current signal and re-starts the PPT counter. If the PPT has not expired, the system updates the MSB with the current signal. Then, the system checks the MSB to determine whether the accumulated signals represent a complete sequence of a specific mode-selection request. If so, the system changes (persistent) mode accordingly and sets PPT as expired. The system tracks (memorizes) the mode and stays in that mode until next mode-selection request arrives (persistent mode). The user input of each control is used to control the corresponding function according to the current mode.

The N-persistent-mode pointing device of the present invention has the following advantages.
(1) It allows practically any desired number of modes and can control any desired number of functions with limited number of controls.
(2) User only has to operate the mode-selection means once when changing mode (no press and hold are needed)
(3) The mode-selection means does not tie down any part of the user's hand so the entire hand is free for operating the controls.
   With essentially the same number/type of hardware components as the prior art dual-mode designs, the N-persistent-mode design of the present invention overcomes the disadvantages of the dual-mode designs listed in (B2) to (B4). Note that the dual-mode designs control only one more motion function than the single-mode designs with same number/type of controls, while the N-persistent-mode design of the present invention can control practically any desired number of functions.

Furthermore, with the N-persistent-mode design of the present invention, a target motion (direction and rate) is completely controlled by the motion control without any additional rate control. Target motion can occur along any direction and always intuitively corresponds to the motion of the motion control. In other words, the present invention further overcomes all disadvantages of the dominant-axis designs as listed in (C1) to (C5).

In practice, each user usually uses only a subset of the available functions that are pertinent to his or her specific work. The N-persistent-mode correspondence between controls and functions may be alterable, namely, a user can select a desired set of functions and customize the N-persistent-mode correspondence to suit individual needs. Even if a user wants to keep all available functions, he or she still can customize the N-persistent-mode correspondence for convenience. This is particularly useful with sequential-accessible modes. A graphical configuration interface may be provided that allows a user to add functions to and remove functions from each mode. It is logical and convenient to group the similar and related functions into same mode. Such versatility does not exist in the prior-art single-mode and dual-mode designs. Also, a LCD, array of LEDs, or any other suitable indicator or display may be used to display the selected persistent mode and even a brief description.

It should be emphasized that the difference between the N-persistent-mode design and the prior art dual-mode designs is not just simply the choice between persistent and momentary switches (mode-selection means). Rather, the difference lies deep in the fundamental concept. This is substantiated by the fact that persistent modes can be implemented with a momentary switch, as described above. In fact, what separates the persistent-mode design and momentary-mode design is not what type of hardware component or what kind of signals are used for changing modes, it is what the system does with the signals.

The multi-mode designs (including dual-mode designs, N-mode designs, and the N-persistent-mode design) should not be confused with composite controls that are designed intrinsically for multi-function controls. A composite control actually consists of multiple controls that are physically integrated into one component, where each of the constituent controls works dedicatedly and independently to control a designated function.

One example of composite controls is the tiltable scroll wheel. A tiltable scroll wheel can be rotated backward and forward to control vertical scroll, and can be tilted left and right to control horizontal scroll. Another example of composite controls is the touch pad. A touch pad actually consists of many miniature controls arranged in a 2D array or matrix. A touch pad or these miniature controls can be partitioned into several sections or groups, each being configured as an independent control. For example, the main portion of a touch pad may be configured for cursor control, a vertical strip along the right edge may be configured for vertical scroll control, and a horizontal strip along the lower edge may be configured for horizontal scroll control. Furthermore, each miniature control of touch pads is also a composite control, and it simultaneous detects touch and applied force. The touch detection is used to determine the movement of user's finger while the force (with a predetermined threshold) is mapped to left button click.

The difference is that the multi-mode designs use one elementary control for different functions at different time (in different mode), while a composite control controls several functions simultaneously and each constituent elementary control is dedicated to control only one designated function at all times.

The multi-mode designs should not be confused with the prior art control mapping/redefinition methods, such as redefining mouse middle (or additional) button for a desired function. These mapping/redefinition methods require several steps to complete and cannot be changed on the fly. Because of this reason, users rarely perform such mappings or change them. In other wards, practically they are “permanent”.

As a further improvement to the N-persistent-mode pointing device, a momentary mode may be added to each persistent mode. In each persistent mode, a special momentary signal of predetermined pattern (characteristic/criteria) switches the pointing device to the corresponding momentary mode and switches back to the persistent mode when this special momentary signal vanishes. This design expands the N-persistent-mode pointing device to 2N modes (N persistent modes and N momentary modes), and will be called 2N-mixed-mode design.

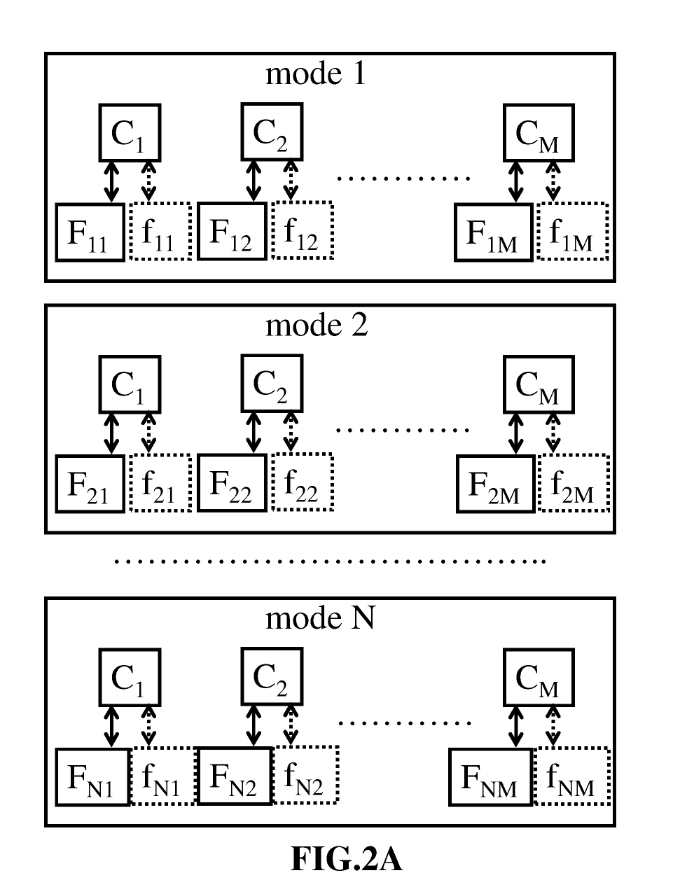

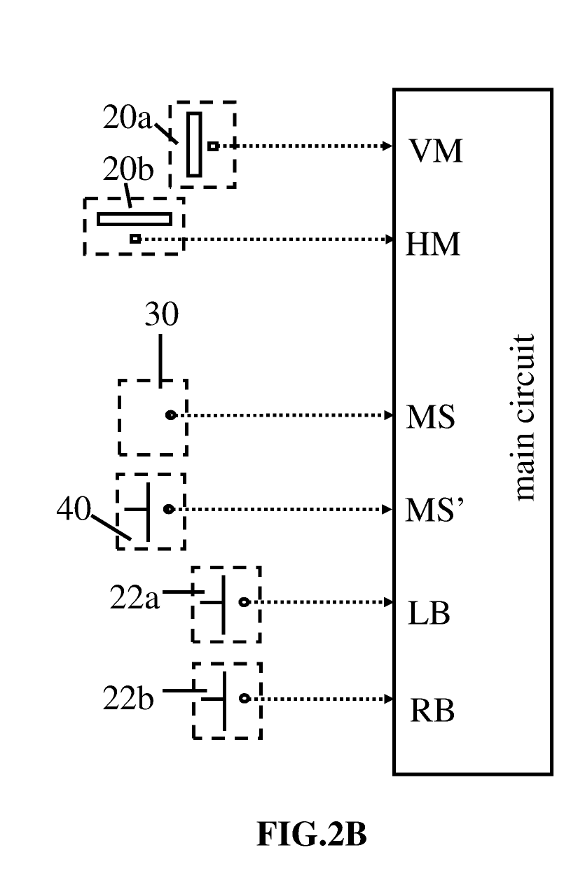

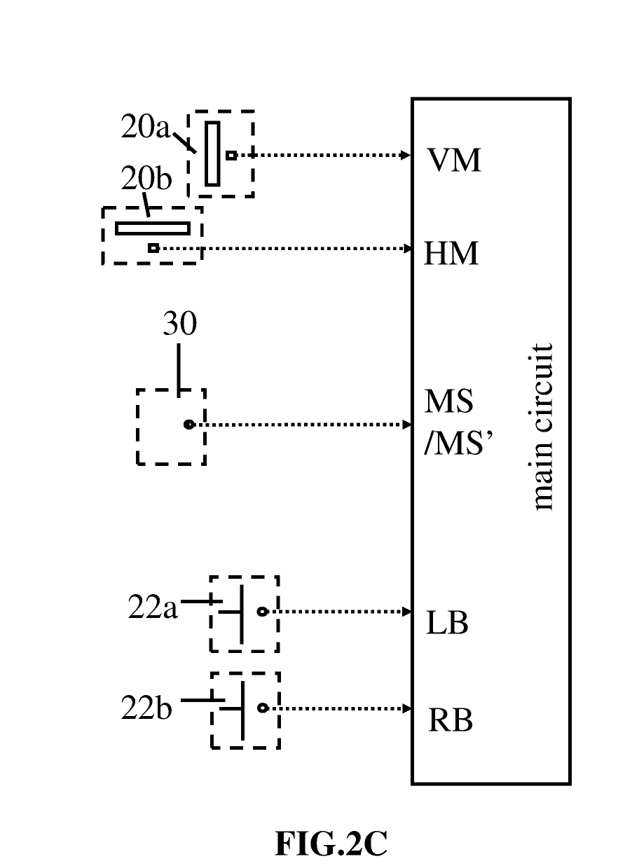

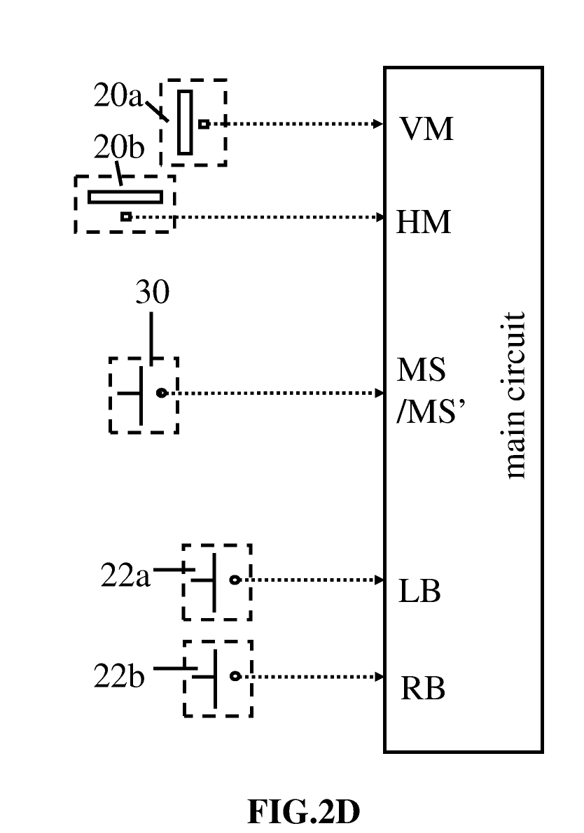

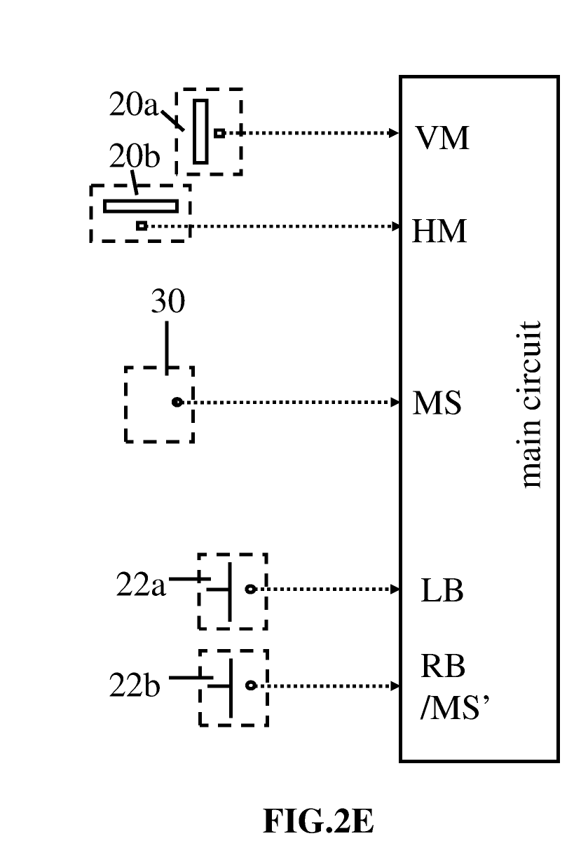

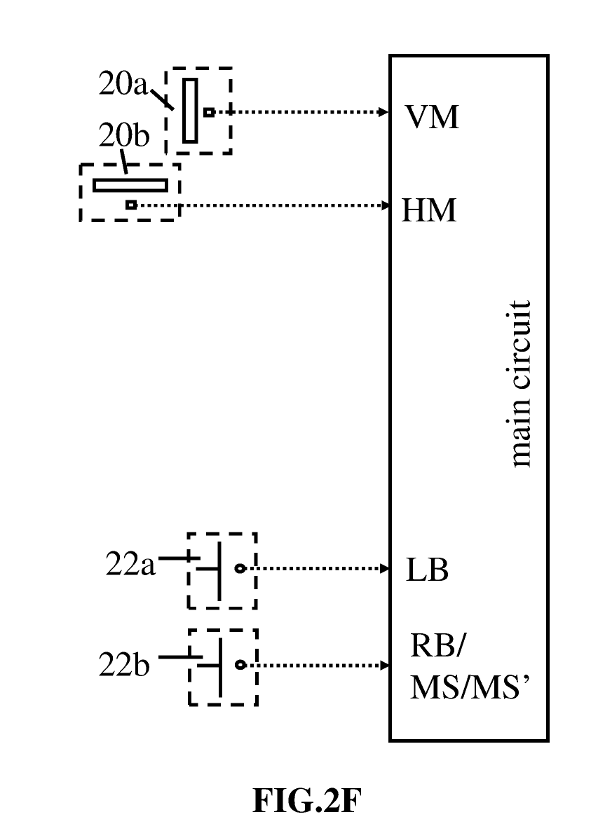

The 2N-mixed-mode design uses a 2N-mixed-mode correspondence as depicted in FIG. 2A. The dashed lines indicate the components related to the momentary modes, and ƒ₁₁,ƒ₁₃, . . . ƒ_{NM} are functions associated to the momentary mode. Some or all of these functions may be new functions, and others may be selected from F₁₁,F₁₂, . . . F_{NM}. In practice, not all controls need a momentary mode in every persistent mode. In the case that a momentary mode is not needed for a specific control in a specific persistent mode (e.g., C₁ in mode 2), the mode switching (to momentary mode) has no effect on this control, and it continues to control the same function for the persistent mode (e.g., F₂₁). This can be equally understood as that the function controlled by this control in the momentary mode is the same as the one in the persistent mode (e.g., ƒ₂₁=F₂₁). For consistency, it will be assumed that every persistent mode has a corresponding momentary mode and every Fᵢⱼ has a counterpart ƒᵢⱼ. This 2N-mixed-mode design can be applied to any multi-mode designs with persistent modes such as the N-persistent-mode design described above or those of Ser. No. 10/636,745 with persistent modes.

The component that supplies the special momentary signal (for switching to the momentary mode) will be called as the mode-switch means to distinct from the mode-selection means for persistent modes. The hardware part of the mode-switch means can be an additional momentary switch (mechanical, electrical, optical, etc.), doubled by the mode-selection means, or doubled by any existing control (button control or motion control). This specific use of the word “double” (doubled by, double as, etc.) means that one hardware component (e.g., mode-selection means or existing control) is used for two (or more) different purposes (e.g., mode-selection means and mode-switch means). The signals generated by this hardware component are inputted to the same signal channel, and the subsequent signal processing differentiates and decodes different types of signals. The signals that indicate different items are either differentiable, or a priority order must be established. If the signals conform to the required pattern (characteristic/criteria) of an item of higher priority, they are recognized as the signals for this item and the corresponding action is taken. Otherwise, the signals are further tested for items of lower priorities.

FIG. 2B shows the schematic view of the 2N-mixed-mode design of the present invention where a dedicated momentary switch 40 is used as the hardware part of the mode-switch means. The signals generated by 40 are inputted to the MS′ signal channel. The mode-selection means 30 is also dedicated (not doubled) but otherwise can be any suitable type.

FIG. 2C shows the schematic view of the 2N-mixed-mode design of the present invention where the mode-selection means 30 doubles as the mode-switch means. The signals generated by 30 are inputted to MS/MS′ signal channel. The mode-selection means/mode-switch means 30 can be any suitable type, as long as it is capable of generating required signals.

FIG. 2D shows a particular case of the embodiment depicted in FIG. 2C, where a dedicated momentary switch 30 doubles as both the mode-selection means and the mode-switch means. For example, predetermined unique sequences of on and off signals within a predetermined period of time indicate the mode-selection requests, while press/hold longer than the predetermined period of time is considered as the special momentary signal.

FIG. 2E shows the schematic view of the 2N-mixed-mode design where one of the button controls (22b) doubles as the mode-switch means. The signals generated by 22b are inputted to RB/MS′ signal channel. For example, press/hold that is longer than a predetermined period of time is considered as the special momentary signal. In this case the mode-selection means is dedicate (not doubled) but otherwise can be any suitable type.

FIG. 2F shows the schematic view of the 2N-mixed-mode design where one of the button controls (22b) doubles as both the mode-selection means and the mode-switch means. The signals generated by 22b are inputted to RB/MS/MS′ signal channel. The mode-switch means may also be doubled by several button controls and/or motion controls. The skilled in the art should appreciate that there are many other combinations based on the fundamental idea of the present invention and they cannot be listed and described one by one.

In the case that the mode-switch means is doubled by the mode-selection means, a constant signal longer than a predetermined period of time may be used as the special momentary signal. Using the embodiment depicted in FIG. 2D as example, a user may operate the momentary switch to produce the unique sequences within the predetermined period of time to select the persistent mode, or press and hold it until the predetermined period of time expires to switch to the momentary mode.

In the case that the mode-switch means is doubled by the existing controls, a press/hold longer than a predetermined period of time may be used as the special momentary signal. The embodiment depicted in FIG. 2E will be used as example. Normally, only a single click is defined for the normal operation of the right button, which causes the display of a drop down (right-button) menu. If the right button down signal and the subsequent right button up signal occur within a predetermined period of time, these signals are recognized as normal operation signals (right button single click) and the drop down menu is displayed. If after the right button down the subsequent right button up does not arrive before the predetermined period of time expires, the button down signal is recognized as the special momentary signal. So the drop down menu is not displayed and the system switches to the corresponding momentary mode. When the right button up signal eventually arrives, the system switches back to the persistent mode.

In the case that both the mode-selection means and the mode-switch means are doubled by the existing controls, a press/hold longer than a predetermined period of time may be used as the special momentary signal. The embodiment depicted in FIG. 2E will be used as example. If the signals generated by the right button control 22b within the predetermined period of time conform to one of the unique sequences of mode-selection request, they are recognized as signals for the mode-selection request and the system changes persistent mode (this item has higher priority) accordingly. Otherwise, a single click that completes within the predetermined period of time is recognized as (normal) right button single click while a press/hold longer than the predetermined period of time is recognized as the special momentary signal. The skilled in the art should appreciate that there are countless variations can be readily generated according to the fundamental idea of the present invention.

The embodiments where a button control doubles as the mode-switch means, such as those depicted in FIG. 2E and FIG. 2F, should not be confused with host-implemented control methods, even though the user operations in the two cases may appear to be similar. For example, in some CAD-type application programs, when a user selects an object and a tool from a toolbar, several handles appear around the selected object. These handles can be dragged with a pointing device to manipulate (move, resize, rotate, etc.) the selected object. U.S. Pat. Nos. 5,396,590 and 5,019,809 suggest different versions of the same idea. Another example is found in word-processing and spreadsheet programs, where there are scrollbars in the form of icons. When a user clicks or drags a specific portion of a scrollbar, the displayed image (e.g., a document) is scrolled accordingly. U.S. Pat. No. 6,972,776 suggests a similar idea, although with more elaborate scroll features.

Host-implemented methods are similar to scroll bars. Host-implemented methods do not involve any mode change. They always use the standard operations, namely, single/double left button click, single right button click, or drag. These standard operations have standard meanings that the computer industry has agreed upon. For example, left button click on an object selects/highlights it, left button double click on an icon of an application starts the application, drag action in a document or image selects/highlights a portion of it. They require virtual buttons and bars in specific points or areas in order to connect the standard operations to specific actions. Or one has to define new meaning for the standard operations where they have no standard meaning (e.g., in areas where there is no selectable object and text).

Another example of host-implemented control methods is that some applications, such as Adobe Acrobat, Microsoft Notepad, Word, and Excel, let user to use the left or middle button and mouse movement to control scroll. Each of these scroll techniques only work in a specific application and can only be implemented by the application provider. Furthermore, because that they are implemented by different application providers, they often behave differently. For example, moving mouse forward causes downward scroll in one application, while it causes upward scroll in another application. The host-implemented methods can only be implemented in the system level, or application level, because it has to relate the standard operations with the current cursor position. This is a severe limitation compared to the present invention.

Therefore, host-implemented control methods have the following disadvantages.
(G1) They can only be implemented in the operating system level or program/application level since they have to associate button control signals with the cursor position on the display.
(G2) They can only be implemented by the operating system or application providers.
(G3) If they are implemented in program/application, they only work in particular program/application.
(G4) If they are implemented in system level, they work with all pointing devices plugged in system, which may be undesirable.
(G5) User has to perform the standard operations in specific points or areas.

In contrast, the N-persistent-mode method of the present invention does not use standard operation sets, rather, it uses predetermined unique sequences of the signals to indicate mode-selection requests. Such operations are clearly differentiable from the normal operations of the controls, hence they can be performed anywhere. Furthermore, N-persistent-mode method of the present invention does not need to associate the button control signals with the cursor position, hence, it can be implemented entirely in the pointing device (hardware and/or firmware), entirely in an additional device (adaptor) that intercept the signals from the pointing device before they reach the computer, entirely in a device driver, entirely in the operating system, entirely in an application, or spread among several or all of them. But the most preferred places of implementations are in the pointing device and/or in an adaptor.

These implementations have the following advantages.
(1) The N-persistent-mode method can be implemented by a device (pointing device or adaptor) manufacturer.
(2) The N-persistent-mode method works only with the designated pointing devices or adaptors (so no surprise to the user).
(3) The N-persistent-mode method works consistently in all applications.
(4) No specific device driver or any other host component is required, so no driver installation and true plug-and-play is achieved.

Therefore, the N-persistent-mode method of the present invention differs completely from the host-implemented control methods and overcomes all disadvantages of the host-implemented control methods as listed in (G1) to (G5).

Like the mode-selection means, the mode-switch means may also comprise several hardware components, for example, two or more switches and/or sensors, and activating any, several, or all of them will cause the system to switch to the momentary mode. The skilled in the art should appreciate that there are countless ways to construct the mode-switch means. Any component or combination of components may be used as the mode-switch means, as long as it is capable of generating a momentary signal while being activated.

Although the momentary mode by itself may be similar to that of the dual-mode designs, the 2N-mixed-mode design differs from the dual-mode design since the momentary mode is additional and is associated to a persistent mode. With basically the same number/type of hardware components as the dual-mode designs, the mixed-mode design of the present invention may control considerably more functions than the dual-mode designs.

The persistent mode and its associated momentary mode may have related functions. For example, persistent scroll mode may have a momentary power scroll mode. When the 2N-mixed-mode pointing device is in the persistent scroll mode, the movement of the motion control (user input) transforms to the distance scroll. When the pointing device is in the momentary mode, the movement of the motion control (user input) transforms to the velocity of the scroll. Also, several or all of the persistent modes may share a common momentary mode. The following two common momentary modes are particularly useful.

One common momentary mode may be the cursor mode. So a user can switch the pointing device momentarily to the cursor mode from several or all of the persistent modes. Suppose that a user is having the pointing device in the persistent scroll mode and is scrolling through a web page when he/she sees a web link of interest. The user presses and holds the mode-switch means (e.g., a momentary switch), and the pointing device switches to the momentary cursor mode. The user then moves the cursor over the web link of interest and clicks it, and the Internet browser jumps to the corresponding new page. The user releases the mode-switch means to resume the persistent scroll mode, and continues to scroll/read the new page. This common momentary mode also has a particular use when a mode-selection menu is used as the mode-selection means (for persistent modes), since a user can switch to the cursor mode momentarily to select a new persistent mode from the mode-selection menu.

Another common momentary mode may be a null mode or motionless mode, where the some or all of the control signals are suppressed. This seemingly useless mode is actually useful in some situations. For example, when the mouse is moved to the boundary of the workspace, the user has to reposition it for the next motion. The reposition usually requires lifting the mouse in the air. A momentary null or motionless mode allows the user to reposition the mouse without lifting it up. The same concept can also be applied to other type of motion controls that have limited operation range. The null mode can also be considered as a normal mode where some or all of the associated functions are null function.

### DETAILED DESCRIPTION—PREFERRED EMBODIMENTS OF THE SECOND ASPECT OF THE PRESENT INVENTION

The second aspect of the present invention is an unconventional method for generating target-motion signals with common motion controls used in pointing devices. In contrast to the conventional implementations, which use the same-cycle static mapping, the present invention uses a dynamic mapping that has never been used or proposed in prior art. As discussed above, static mapping maps the target motion to a predetermined number of user inputs with predetermined time positions relative to that of the target motion, regardless of the properties of these user inputs. In contrast, the dynamic mapping of the present invention maps the target motion to a collection of user inputs that have predetermined properties, regardless of the number of them or their time positions relative to that of the target motion. For clarity and definiteness, a qualification rule that summarizes the predetermined properties will be used, and the user inputs that satisfy the qualification rule (have the predetermined properties) will be called qualified user inputs. According to the present invention, all qualified user inputs that have occurred (current cycle and/or previous cycles) are mapped to the target motion of the current cycle.

For ease of description and mathematic expression, two mathematic quantities, namely, source quantity and target quantity are introduced. The source quantity \vec{S}ᵢ is a mathematic quantity that is derivable from the current collection of qualified user inputs and time reference. The target quantity is a mathematic quantity that is sufficient for updating the target motion of the current cycle. A transformation function \vec{p}( ) is used to transform the source quantity to the target quantity

\vec{R}ᵢ=\vec{p}(\vec{S}ᵢ) (equation 4)

Since in general several properties may be required to update the target motion, so besides the vector nature, \vec{R}ᵢ and \vec{S}ᵢ may each represent several quantities, respectively, and equation 3 may actually consist of several equations. Although equation 4 may look similar to equation 1 or 2, it must be understood that equation 4 does not describe the complete mapping from the user inputs to the target motion, since part of the mapping is hidden in the selection of qualified user inputs (depending on the specific qualification rule) and the relation between the qualified user inputs and the source quantity. Depending on the qualification rule, qualified user inputs may be all user inputs, an indefinite number of user inputs with indefinite relative time positions, a fixed number of user inputs with indefinite relative time positions, or even one user input with indefinite relative time position. All these are characteristic of the QR-based dynamic mapping, and differ from the characteristics of the static mappings. Examples of all these cases will be given later.

In summary, the dynamic mapping of the present invention comprises the following steps:
(i) choosing a suitable qualification rule;
(ii) screening for the qualified user inputs according to the qualification rule;
(iii) mapping the qualified user inputs to a suitable target quantity that is sufficient for updating the target motion.

Mathematically, the step (iii) is broken into two sub steps, namely, (iiia) deriving a suitable source quantity from the qualified user inputs and time reference (if required) and (iiib) transforming the source quantity to the target quantity via a suitable transformation function. The dynamic mapping of the present invention as defined in (i) to (iii) will be called as qualification-rule-based dynamic mapping or shortly as QR-based dynamic mapping.

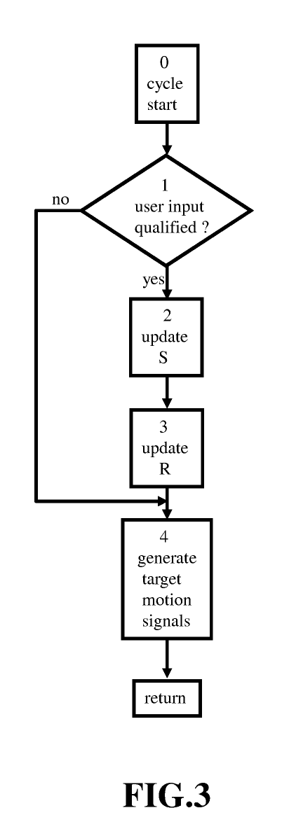

Refer to FIG. 3 for the operation of the QR-based dynamic mapping of the present invention. In each cycle, the user input is screened in step 1. If the current user input is qualified, the source quantity \vec{S}ᵢ is updated in step 2. The target quantity \vec{R}ᵢ is then updated in step 3 according to equation 4. And finally in step 4, the target-motion signals (or data) that update the target motion are generated according to the target quantity \vec{R}ᵢ. If in step 1 the current user input is not qualified, steps 2 and 3 are bypassed, hence, \vec{S}ᵢ, \vec{R}ᵢ, and the target-motion signals are the same as those in the previous cycle. The computer uses the target-motion signals generated in step 4 to update the target motion for that cycle.

According to the QR-based dynamic mapping of the present invention, if the user input in a cycle is not qualified, the target motion of that cycle maps to those qualified user inputs occurred in previous cycles. This provides the possibility for the target motion to continue, even if the user inputs in some cycles are not qualified. This is an important property of the dynamic mapping of the present invention, which removes the intrinsic property of the static mappings. This separates the QR-based dynamic mapping of the present invention from the prior art static mappings and dynamic mappings. This property brings about significant advantages and overcomes all disadvantages of the prior art static and dynamic mappings, which will be explained in various exemplary embodiments later.

Other types of dynamic mappings have been used or proposed in prior art for various purposes. For example, U.S. Pat. No. 5,963,195 adds an additional speed/acceleration control to a mouse, which allows a user to adjust the gain dynamically. U.S. Pat. No. 6,433,776 uses a mouse motion control where the motion along one dimension (e.g., horizontal motion) controls the gain for the motion along the other dimension (e.g., vertical motion). If the 2D mouse motion control is viewed as two independent 1D motion controls, U.S. Pat. No. 6,433,776 uses one of the 1D motion controls to dynamically adjust the gain of the other. U.S. Pat. No. 6,981,229 teaches a method for coordinating two pointing device, where the gain of one pointing device is controlled by the view point on the display, which is controlled by another pointing device.

A common characteristic of these prior art dynamic mappings is that they only dynamically alter the transformation function ƒ( ) of the same-cycle static mapping (the target motion still maps to the user input of the same cycle). Dynamically altering the transformation function by itself does not change the intrinsic property of the static mappings, namely, the target motion ceases when the user inputs cease. As explained previously, this intrinsic property is the major source for the deficiency of the static mappings. Therefore, these prior art dynamic mappings do not remove most of the disadvantages of the static mapping.

In summary, these prior art dynamic mappings have the following common disadvantages.
(H1) they require additional device, motion control, or host component;
(H2) the target motion of every cycle maps only to the user input of the same cycle;
(H3) they only alter the transformation function;
(H4) they do not remove the intrinsic property of the static mappings, hence, most of the disadvantages of the static mapping still exist.

U.S. Pat. No. 6,981,229 has a further disadvantage, namely, (I1) it can only be implemented in the host or at least requires a host component to coordinate the two pointing devices. U.S. Pat. No. 5,877,748 uses a three-level transformation function based on which of the three zones (non-motion, proportional motion, and power motion) the mouse is in. Although this design does not require additional device or motion control like other examples above, it shares the disadvantages (H2) to (H4). U.S. Pat. No. 5,877,748 has further disadvantages, namely, (J1) the three zones are virtual zones and the user does not know precisely the boundaries of them; (J2) the response changes abruptly and suddenly across the zone boundaries.

None of these prior art dynamic mappings has any similarity to the QR-based dynamic mapping of the present invention as defined in (i) to (iii), and none of the prior art dynamic mappings removes the intrinsic property of the static mapping. The QR-based dynamic mapping of the present invention successfully removes the intrinsic property of the static mapping and do not have any of the disadvantages of the prior art dynamic mappings.

In the following, a series of exemplary embodiments will be given to provide detailed description of the present invention. For the sake of clarity and definiteness, 2D target motion controlled by a 2D motion control will be used as example. The skilled in the art should appreciate from the descriptions bellow that the present invention can be applied to any dimensionality.

The exemplary embodiments of the second aspect of the present invention start with isotonic motion controls, and a 2D trackball will be used as example of hardware. Several other exemplary embodiments using isotonic and isometric motion controls will be given later.

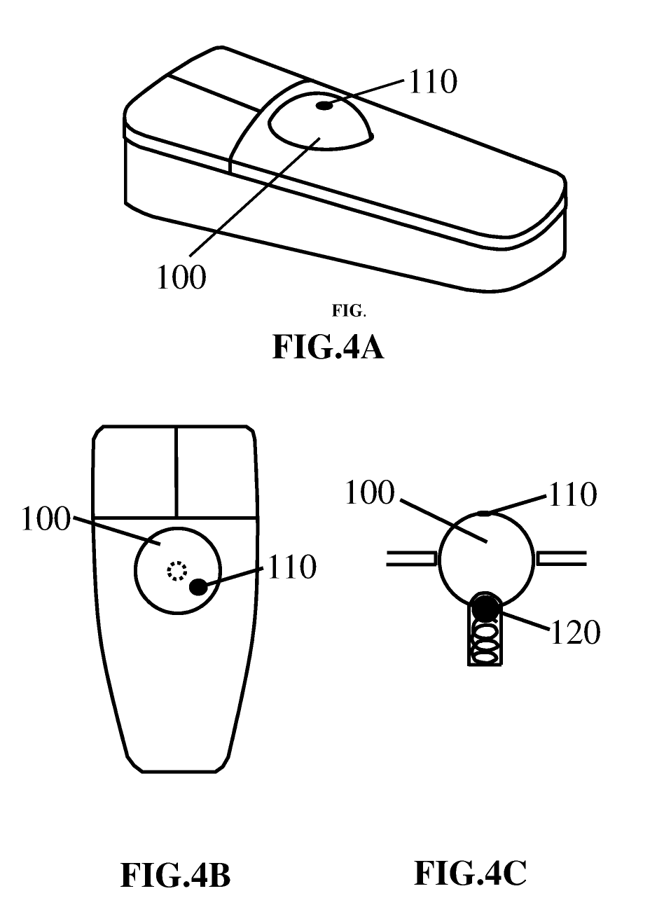

According to the present invention, a center (or a virtual center) position is assigned to the trackball (recall that isotonic motion control does not have a center position naturally). As shown in FIG. 4A and FIG. 4B, a trackball 100 is located on the top surface of a pointing device for controlling a 2D target motion. The trackball 100 has a dot 110 that marks the center (or virtual center) position. A physical center position may be built into the trackball, as depicted in FIG. 4C. The trackball in FIG. 4C has a recess of substantially half-sphere shape opposite to the center mark, and a spring-biased roller ball 120 provides latching and tactile feedback when the trackball leaves from or returns to its center. The skilled in the art should appreciate that many other suitable mechanisms can be used for the same purpose. Frictional or latching mechanisms may be further added to reduce inadvertent rotation and/or to restrict the range of rotation, which are well known in the art and will not be elaborated here. In this case, the user input is proportional to the incremental rotation of the trackball in a cycle.

In one exemplary embodiment, all user inputs are considered qualified user inputs, and the vector sum of all qualified user inputs is used as the source quantity. The velocity of the target motion is used as the target quantity. For this embodiment, equation 4 has the specific form

$${( \frac{d \vec{T}}{d t} )}_{i} = \vec{p} ( {\vec{S}}_{i} ) \qquad ( equation 4.1 )$$

Preferably but not necessarily, at least in certain range or ranges the transformation function \vec{p}( ) is monotonic, where it increases monotonically as the argument increases. Preferably but not necessarily, the direction of \vec{p}( ) and \vec{S} has a predetermined correspondence. For example, backward-forward rotation of the trackball controls vertical scroll, side-to-side rotation controls horizontal scroll, and diagonal rotation controls diagonal scroll. The transformation function may be linear, multi-level linear, or nonlinear.

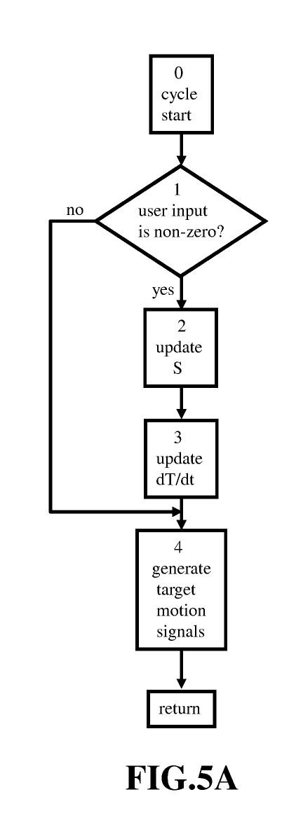

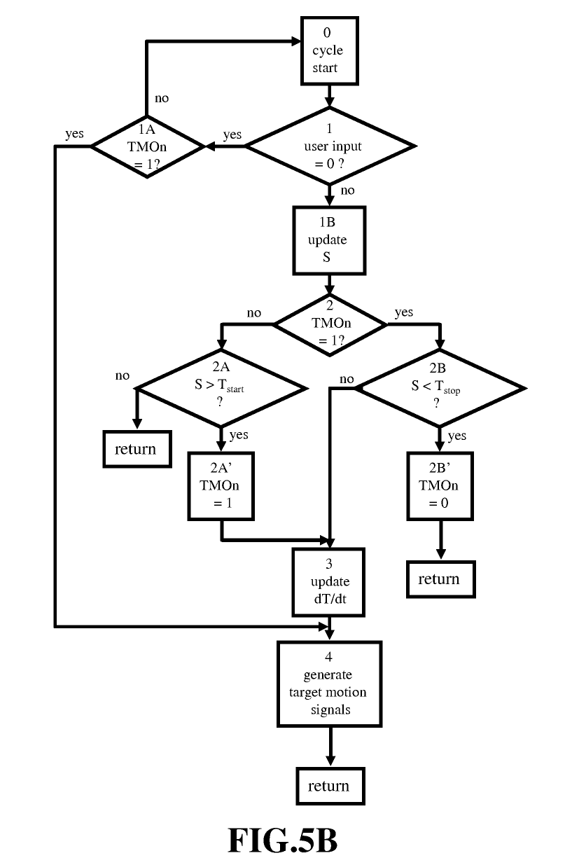

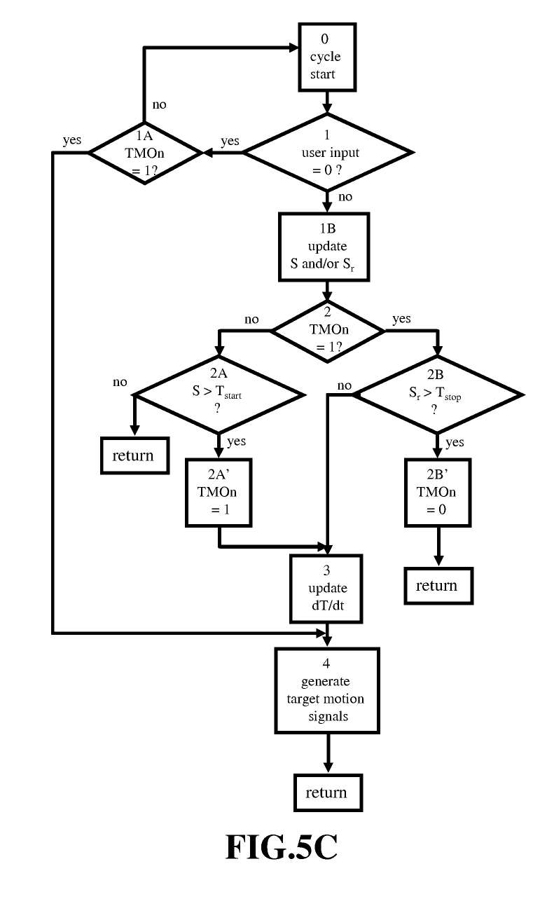

FIG. 5A shows the operation of this embodiment. In every cycle, the system checks current user input in step 1. If the user input of the current cycle is non-zero, the system updates the source quantity \vec{S} in step 2. The system then updates the velocity of target motion (target quantity) in step 3. The system generates target-motion signals in step 4 based on the velocity. If in step 1 the current user input is zero, steps 2 and 3 are bypassed, hence, \vec{S}ᵢ, (dT/dt)ᵢ, and the target-motion signals are the same as those in the previous cycle. After step 4, the system returns to step 0 to start the next cycle.

In this embodiment, the qualification rule may be understood as either that all user inputs are qualified or that only the non-zero user inputs are qualified, since zero user inputs do not contribute to the source quantity in this case anyway. The former does not exclude any user input but the later does exclude some user inputs. Either way, as time progresses, the target motion maps to more and more user inputs. If non-zero user inputs are considered qualified user inputs, the step 1 of FIG. 5A represents screening of qualified user inputs. If all user inputs are considered qualified user inputs, no screening of qualified user inputs is actually required, and step 1 of FIG. 5A may be considered as a step to improve the efficiency of the algorithm.

With this embodiment, a user displaces the trackball from its center along a desired direction (as depicted in FIG. 4B), and the corresponding 2D target motion starts. With a monotonic transformation function, a small displacement from the center position corresponds to slow target motion velocity and a large displacement from the center position corresponds to fast target motion velocity. The user can alter the velocity (magnitude and direction) of target motion smoothly and continuously by adjusting the displacement of the trackball from its center position. Since a trackball has a relatively larger operation range than common isometric motion controls, such as joystick or TrackPoint, more accurate target motion can be achieved. When a desired velocity of the target motion is achieved, the user can let the target motion continue by simply leaving the trackball in that position. So steady target motion is easily maintained without any jittering or fluctuation. Therefore, target motion is easily, intuitively, continuously, and smoothly controlled by the user.

From the description of this embodiment, the QR-based dynamic mapping of the present invention has the following advantages.
(1) Both accurate and fast target motion can be easily obtained.
(2) Large amount target motion does not require large operation space and/or repeated repositions.
(3) Continuous target motion does not require continuous user operation.
(4) Fast target motion does not require fast user operation or large force.
(5) Steady target motion is easily maintained, which does not require a steady user input.
   In other words, the present invention overcomes all the disadvantages of the conventional implementations of isotonic and isometric motion controls as listed in (D1) to (F4).

Furthermore, with the QR-based dynamic mapping of the present invention, one motion control controls the target motion completely, dynamically, and continuously, without needing any additional control, device, virtual zones, or host component. The QR-based dynamic mapping of the present invention further overcomes all the disadvantages of the prior art dynamic mappings, as listed in (H1) to (J2).

Since the target motion may not cease when the user input ceases, a stop control is needed for a user to stop the target motion. Although a start control is not strictly required, since the target motion is ultimately determined by equation 4, it helps to prevent inadvertent or false start. A natural start/stop control is to make \vec{p}(0)=0. But this start/stop control requires the user to return the trackball to its center in order to stop the target motion. An effective start/stop control eases the user operation and helps to prevent inadvertent or false start and stop. One exemplary embodiment of the start/stop control uses predetermined start threshold Tₛₜₐᵣₜ and stop threshold Tₛₜₐᵣₜ. When the magnitude of the source quantity S exceeds Tₛₜₐᵣₜ, the target motion starts, and when it drops below Tₛₜₒₚ, the target motion stops. One or both of the thresholds may be zero (no threshold). Preferably but not necessarily, Tₛₜₐᵣₜ should be greater than Tₛₜₒₚ to allow a “hysteresis”. If Tₛₜₐᵣₜ<Tₛₜₒₚ is used, the scroll should start only when the displacement is rising and crossing Tₛₜₐᵣₜ. In other words, user has to return the control to the proximity of the center (so the displacement goes below the threshold) to re-start.

FIG. 5B shows the operation of the QR-based dynamic mapping of the present invention with the start and stop controls as described above. In every cycle, the system checks if the user input is non-zero at step 1. If the user input is non-zero, the system goes to step 1B and updates \vec{S}. In step 2 the system checks a TMOn (Target Motion On) flag to determine if the target motion is already on. If the target motion is off (TMOn=0), the system goes to step 2A to compare the magnitude of S with the start threshold Tₛₜₐᵣₜ. If S<Tₛₜₐᵣₜ, the system returns to step 0 (no target motion). Otherwise, it sets TMOn=1 in 2A′ and proceeds to step 3. In step 3, the system updates the velocity of the target motion. Then in step 4, the system generates target-motion signals (data) according to the velocity and returns to step 0. If in step 2 the target motion is already on (TMOn=1), the system goes to step 2B to compare the magnitude of S with the stop threshold Tₛₜₒₚ. If S<Tₛₜₒₚ, the system sets TMOn=0 in step 2B′ and returns to step 0. Otherwise it proceeds to step 3. If in step 1 the user input is zero, the system checks TMOn flag in step 1A. If the target motion is already on (TMOn=1), the system proceeds to step 4 and generates the same target-motion signals as previous cycle. Otherwise, the system returns to step 0 (no target motion). Notice that in this embodiment the start/stop control and the target motion control are all based on the same quantity (i.e., \vec{S}).

Another example of stop control uses a different quantity \vec{S}ᵣ, namely, the vector sum of the user inputs from the point where the user input reverses direction. When the user wants to stop the target motion, he/she turns the trackball in substantially opposite direction of the current target motion, and the system begins to accumulate \vec{S}ᵣ from the point of the reverse. When the magnitude of \vec{S}ᵣ exceeds a predetermined stop threshold, the target motion stops. FIG. 5C shows the operation of this embodiment.

In general, the start control, target motion, and the stop control may each be based on a different quantity. There are many quantities that may be suitable for start/stop control. For example, the start/stop control may use velocity/acceleration of user input, where the target motion starts when the velocity/acceleration of the user input exceeds a predetermined start threshold and stops when the velocity/acceleration of user input substantially reverses the direction and then exceeds a predetermined stop threshold. Or, alternatively, the start control is based on the vector sum of the qualified user inputs the stop control is based on the velocity/acceleration, or vice versa. And instead of the start and stop thresholds, more general control protocol may be used, where unique patterns/sequences/criteria of user inputs are used to indicate control requests for starting or stopping the target motion. The skilled in the art should appreciate that countless patterns/sequences/criteria can be used based on the fundamental idea and spirit of the present invention, which cannot be listed and/or described one by one.

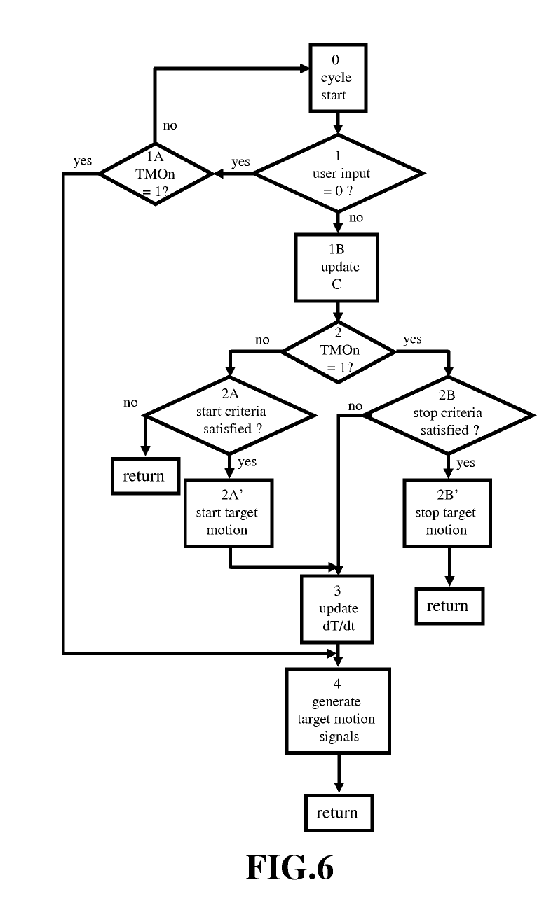

FIG. 6 shows the QR-based dynamic mapping with general start and stop criteria. It should be note that in step 2A′ “start target motion” means all necessary housekeeping steps before target motion starts, such as setting TMOn flag, etc. Whether the target motion starts or not is ultimately determined by equation 4. In fact, the start control is not strictly required. In step 2B′ “stop target motion” includes all necessary housekeeping steps to terminate the target motion, such as resetting TMOn flag, etc.

Notice that for ease of explanation and mathematics, the vector nature is deliberately ignored in the above description of start/stop control. For multi-dimensional motion control, each dimension may have independent start/stop control and works exactly as described above. Or, a joint start/stop control may be used. For example, one may allow the target motion to occur in only one dimension at a time, depending on which dimension the displacement has the largest component. Another example is that one may have the target motions in both dimensions to start and operate independently, but they both stop when the stop criteria in any dimension is met. Yet another example is that the target motions in both dimensions stop simultaneously when the fastest one stops. The skilled in the art should appreciate that there are countless combinations and implementations can be created based on the fundamental idea and spirit of the present invention.

In the above embodiments, the trackball has a fixed center. Alternatively, a re-center control may be used, which allows a user to re-center the trackball or any other type of isotonic control. The re-center control consists of assigning a new center (or virtual center) position to the state of the isotonic control (e.g., trackball), which mainly amounts to resetting (emptying) the collection of qualified user inputs. The re-center control may be independent, and a user can re-center the motion control at any state. Or, it may be combined with the start control or the stop control. If the re-center is combined with the stop control, the tasks required by the re-center should be added to step 2B′ of FIG. 5B, FIG. 5C, and FIG. 6. If the re-center is combined with the start control, the tasks required by re-center should be added to step 2A′ of FIG. 5B, FIG. 5C, and FIG. 6. An independent re-center control may use a specific pattern (sequence/criteria) of the user input (differs from those used by start and stop controls) as indication.

In summary, a control protocol for start control (if implemented), stop control and re-center control (if independent) may be used. The control protocol uses up to three predetermined unique patterns (sequences/criteria) of user inputs to indicate, respectively, start, stop, and (independent) re-center. The control protocol may use as few as one unique pattern, which indicates toggling the start/stop and re-centering at the same time. The start control (if implemented), stop control, and re-center control (if independent) have higher priority than the normal operations of the motion control. In other words, the motion-control signals are always tested first to determine if they conform to the control protocol. If they do, the corresponding control actions (start, stop, or re-center) are taken and these motion-control signals may be either modified or passed on as (normal) user inputs. Otherwise, they are passed on as (normal) user inputs.

With the re-center control, no center mark or physical center is used, and the user does not have to return to the previous center to start the next target motion but simply starts it from the new center. As a matter of fact, the embodiment of a trackball with fixed center (as depicted in FIG. 4A to FIG. 4C) only serves the purpose of teaching the fundamentals of the QR-based dynamic mapping of the present invention. A practical embodiment should always implement the re-center control, since a real motion control will inevitably produce error and the center will inevitably drift.

So far, the exemplary embodiments have all been based on the same hardware motion control, namely, a trackball. The QR-based dynamic mapping of the present invention can be equally applied to other isotonic motion controls, for example, a touch pad. With a touch pad, a finger slide by the user produces an incremental user input with direction and magnitude. Since a fixed center cannot be established with a touch pad, a re-center control (independent or combined) must be used. The operation of this embodiment is almost identical to that of the trackball. The user can alter the velocity (direction and magnitude) of the target motion continuously by sliding his/her finger on the touch pad accordingly. When a desired velocity is achieved, the user can maintain it by simply stopping finger sliding. To stop the target motion, the user slides his/her finger with a predetermined pattern that satisfies the stop criteria.

Similarly, the QR-based dynamic mapping of the present invention can be applied to a mouse motion control. Although a fixed center may be established based on the position of the mouse on the desk or mouse pad, the re-center control of the present invention as described above is preferred. The user can alter the velocity (direction and magnitude) of the target motion continuously by moving the mouse accordingly. When a desired velocity is achieved, the user can maintain it by simply leaving the mouse in its current position. To stop the target motion, the user moves the mouse with a predetermined pattern that satisfies the stop criteria. This embodiment is particularly powerful for document scroll, which will be described in the third aspect of the present invention.

It should be emphasized that the stop control and the re-center control are particularly useful for the isotonic motion controls where a fixed center cannot be established or is difficult to establish. With these motion controls, a user does not have a spatial reference to the center. The stop control and the re-center control of the present invention as described above allows a user to start/stop the target motion from the current position/state of the motion control, no spatial reference is ever needed.

The QR-based dynamic mapping of the present invention can also be applied to isometric motion controls. In fact, the QR-based dynamic mapping of the present invention works equally well for any type of motion controls and any type of motion functions, as long as a suitable form of the QR-based dynamic mapping (qualification rule, source quantity, target quantity, and transformation function) is used. Several exemplary embodiments will be given in the following to further demonstrate the generality and flexibility of the present invention. To reduce the parallel descriptions for isotonic and isometric motion controls, the two types of motion controls will be distinguished only when necessary.

In one exemplary embodiment, qualified user inputs are those whose magnitudes exceed a predetermined threshold, and the vector sum of the qualified user inputs is used as the source quantity. With this embodiment, the number of qualified user inputs and their relative time positions are indefinite. If the predetermined threshold is zero, all non-zero user inputs are qualified user inputs. A small (non-zero) threshold helps to eliminate the effect of tremor produced by user.

In another exemplary embodiment, the qualified user input is the most recent user input whose magnitude exceeds a predetermined threshold, and the qualified user input is used directly as the source quantity. Every time a qualified user input is produced, it replaces the previous one (no longer qualified). So the collection of qualified user inputs has at most one member, but the relative time position of the user input is indefinite. If the predetermined threshold is zero, the target motion maps to the most recent non-zero user input.

In yet another exemplary embodiment, the qualified user inputs are the N most recent user inputs whose magnitudes exceed a predetermined threshold, and the average of the qualified user inputs is used as the source quantity. When N=1, this embodiment reduces to that immediately above. Every time a qualified user input is produced, it replaces the oldest member of the qualified user inputs. The collection of qualified user inputs has up to N members, but their relative time positions are indefinite. This embodiment can substantially reduce the fluctuation of user inputs, without additional filter. This embodiment is perhaps most advantageous when implemented with an isometric motion control, such as joystick or TrackPoint, to reduce the jittering effects. It should be noted that a static mapping plus a filter still represents a static mapping, since the filtering is always performed on a fixed number of user inputs with fixed relative time positions.

In yet another exemplary embodiment, the qualified user input is the one of maximum magnitude, and the qualified user input is used directly as the source quantity. Every time a qualified user input is produced, it replaces the previous one. The collection of qualified user inputs has at most one member, but the relative time position is indefinite. With this embodiment, only the user input whose magnitude exceeds all those of previous user inputs is effective.

In yet another exemplary embodiment, the qualified user inputs are those that increase the magnitude of the source quantity, and the vector sum of the qualified user inputs is used as the source quantity. The first non-zero user input is always a qualified user input, which becomes the initial source quantity. Any subsequent user input is a qualified user input if it will increase the magnitude of the source quantity. Both the number of qualified user inputs and their relative time positions are indefinite. This embodiment practically “extends” the operation range of the motion control to infinite. When applied to an isotonic control, for example, a mouse motion control, a user does not need to pick up the mouse from the desk to reposition it to the center position. When applied to an isometric motion control, for example, a joystick, a user can repeatedly push and release the shaft substantially along a desired direction to continuously increase the velocity of the target motion. In other words, the operation ranges of both types of controls are extended to infinite.

The source quantity may also depend on the velocity, acceleration, any order of time-derivatives of the qualified user inputs, or any combination of them. The skilled in the art should appreciate that there are countless choices for the source quantity, which cannot be list and/or described one by one. According to the definition, any suitable quantity that is derivable from the user inputs and time reference can be used as the source quantity.

Likewise, many suitable quantities other than the velocity may be used as the target quantity. The incremental target motion, the velocity of target motion, the acceleration of target motion, any order of time-derivative of the target motion, or any suitable combination of them, may be used as target quantity. The skilled in the art should appreciate that there are countless choices for the target quantity, which cannot be list and/or described one by one. According to the definition, any quantity that is sufficient for updating the target motion can be used as the target quantity.

Furthermore, the transformation function may also be altered dynamically. Similar to the control protocol, a predetermined unique pattern (sequence/criteria) of user inputs may be used to indicate a specific request for altering the transformation function. There may be several predetermined transformation functions to choose from, or there may be one transformation function that can be altered continuously.

Further generalization along the same line may include alteration of qualification rule, source quantity, and target quantity, start control, stop control, re-center control, and transformation function. A general mapping-alteration protocol may be used, which uses predetermined unique patterns (sequences/criteria) of user inputs to indicate specific mapping-alteration requests. Each specific mapping-alteration request may alter only one or several of the components, including qualification rule, source quantity, target quantity, start control, stop control, re-center control, and transformation functions. One may have several predefined QR-based dynamic mappings for user to choose. These predefined QR-based dynamic mappings may be arranged for sequential access or random access, similar to the sequential accessible and random accessible modes described in the first aspect of the present invention. More elaborate and detailed alterations of the QR-based dynamic mapping may also be used to allow users to dynamically customize/tailor their desired QR-based dynamic mapping in any suitable ways. Methods that are similar to those used for mode-selection protocol and control protocol may be adopted for the mapping-alteration protocol. The only requirement is that the unique patterns (sequences/criteria) for mapping-alteration protocol are distinct from those for control protocol, or a priority order is established. The mapping alteration and start/stop/re-center controls have higher priority than the normal operation of the motion control.

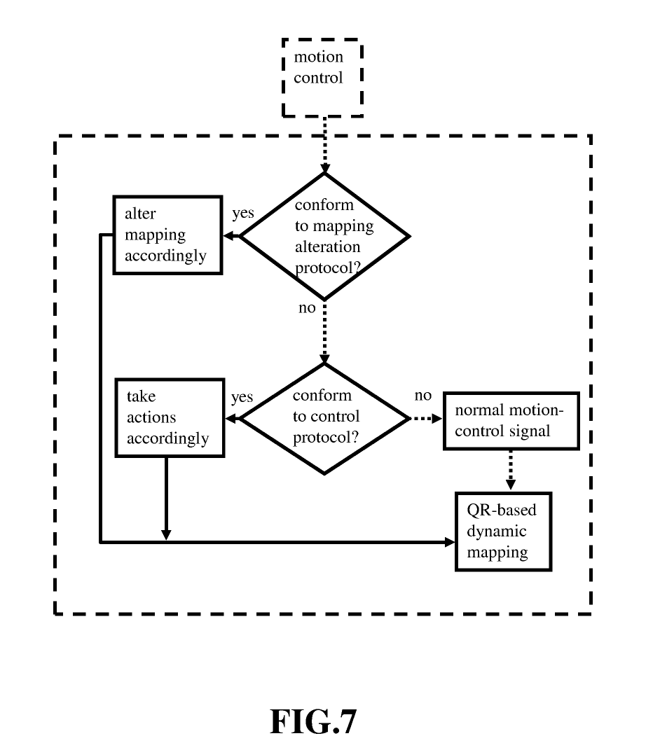

FIG. 7 shows the operation of the general system that includes mapping-alteration protocol and control protocol. The motion control signals are first tested to determine if they conform to the mapping-alteration protocol. If so, the QR-based dynamic mapping is altered accordingly. Otherwise, the motion-control signals are tested to determine if they conform to the control protocol. If so, corresponding actions (start, stop, re-center, or combination of them) are taken and the motion-control signals may be passed on or modified. If the motion-control signals do not conform to any of these protocols, they are passed on as normal motion-control signals (user inputs) and are mapped to the corresponding target motion. The dotted arrows of FIG. 7 indicate that the signal is passed without modification.

Different qualification rules, control quantities, target quantities, transformation functions generally produce different target motion properties. The skilled in the art should appreciate that there are countless suitable combinations of qualification rule, source quantity, target quantity, transformation function, start control, stop control, and re-center, and they cannot be listed and/or described one by one. It should also be clarified that the control protocol and mapping-alteration protocol are peripherals and not the essential components of the QR-based dynamic mapping. The essential components of QR-based dynamic mapping are defined in (i) to (iii). These peripherals provide further flexibilities and possibilities for the user to control the target motion more effectively and/or more efficiently.

With all these advantages, the implementation of the present invention is extremely simple and flexible. With the present invention, all aspect of the target motion, including target motion, start/stop/re-center, and even the alteration of start/stop/re-center methods and the QR-based dynamic mapping, is controlled by one motion control, without any additional control, device, or host component. Furthermore, the QR-based dynamic mapping of the present invention only requires very simple data processing, as can be easily seen in FIG. 6 and FIG. 7. Therefore, the QR-based dynamic mapping of the present invention can be implemented entirely in the pointing device (hardware and/or firmware), entirely in an additional hardware device (e.g., keyboard, or adaptor), entirely in a device driver, entirely in the operating system, entirely in an application, or spread among several or all of them.

The most preferred place for implementation is inside the pointing device. The second preferred place for implementation is inside an additional hardware device that intercepts the signals from the pointing device, modifies them, and/or generates new signals according to the present invention. This additional device may be either a keyboard or an adaptor. These implementations can be carried out by device (pointing device, keyboard, or adaptor) manufacturers, rather than rely on operating system or application providers. They also allow the present invention to work only with the designated pointing devices and in all suitable applications, rather than with all pointing devices and in specific applications. Furthermore, no software (device driver, host component) and user installation of software is required, so the true plug and play is achieved.

### DETAILED DESCRIPTION—PREFERRED EMBODIMENTS OF THE THIRD ASPECT OF THE PRESENT INVENTION

The third aspect of the present invention combines the multi-mode designs (including dual-mode designs, N-mode designs, N-persistent-mode designs, and 2N-mixed-mode designs) and the QR-based dynamic mapping to take their separate advantages and produce even more dramatic combined advantages. A mouse motion control will be used as the hardware example to describe the third aspect of the present invention. From the description below, the skilled in the art should appreciate that the third aspect of the present invention applies to almost all types of pointing devices.

Mouse motion control, especially optical mouse motion control, is by far the most accurate and intuitive motion control among all types of motion controls for cursor motion. However, a pointing device usually may have only one such motion control. In order for other motion functions to benefit from it, the control sharing or multi-mode method must be used. But the problem is that, with static mapping, the mouse motion control may not be effective and/or efficient for other types of motion functions. The most significant disadvantage of mouse motion control with static mapping is that large amount/fast/continuous target motion requires large amount/fast/continuous mouse motion. Fortunately, cursor movement is limited to within the display screen, so the static mapping is adequate for the mouse motion control and cursor motion pair. But if one wants to use a mouse motion control for a different motion function, such as scroll, the situation is quite different.

The requirements for scroll control are much more diverse. The desired amount of scroll (target motion) may vary from a few lines to thousands of lines, and the desired rate of scroll (velocity of target motion) may vary from very slow (e.g., while reading) to very fast (e.g., while scanning for items of interest). So simply use a mouse motion control with static mappings for both cursor and scroll control, as suggested by some of the prior art dual-mode designs, would not provide effective and efficient scroll control in all situations. For large amount of scroll, a user has to reposition (i.e., picking up and putting down in another place) and then move the pointing device, repeatedly. And for fast scroll, the user has to move the pointing device at a fast pace. The fast motion means that the available working space is used up quickly, which forces the user to reposition the pointing device even more frequently. Frequent reposition of the pointing device not only is tedious but also stops the scroll in the mean time. That results a very ineffective and inefficient scroll control.

The solution is to combine the multi-mode designs with the QR-based dynamic mapping of the present invention. The multi-mode designs allow one motion control to control multiple motion functions, while QR-based dynamic mapping improves effectiveness and efficiency of motion controls. Since the mouse motion control with static mapping is adequate and familiar for cursor motion, one can use it for cursor mode and use the QR-based dynamic mapping for scroll mode. Therefore, not only both cursor and scroll are controlled by the same motion control, but also each of them is controlled most effectively and efficiently. In general, a specific form of mapping (static or dynamic) should be chosen for each pair of motion control/motion function based on their characteristics.

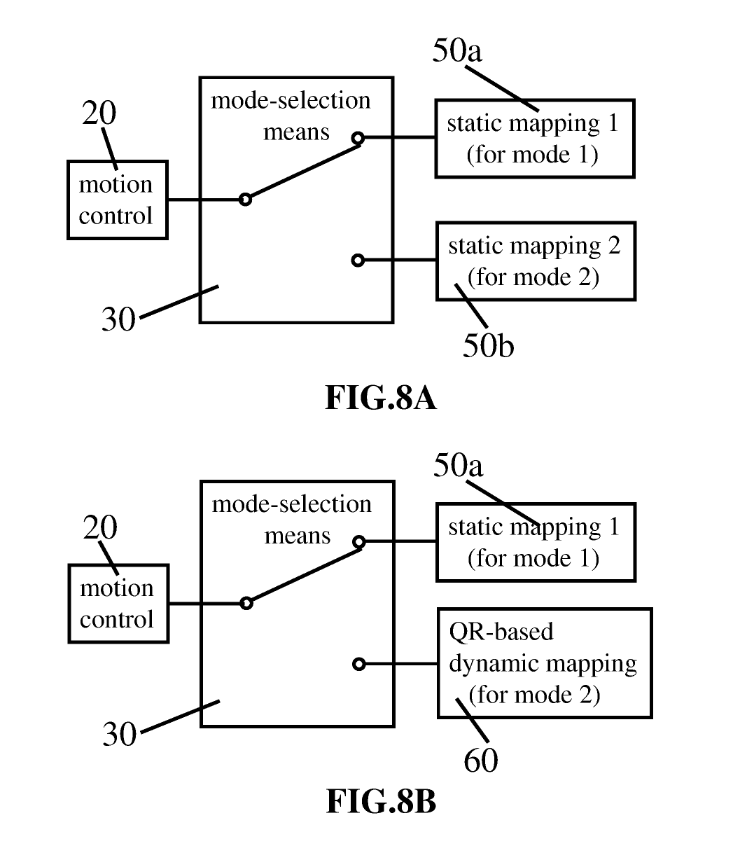

In the exemplary embodiments described below, at least in one mode and at least for one motion function the QR-based dynamic mapping of the present invention is used, even though the corresponding figures may not depict this explicitly. Therefore, even if the prio art dual-mode designs or the N-mode designs of Ser. No. 10/636,745 are adopted for the multi-mode part, the third aspect of the present invention still differs from the prior art designs since it uses a different/new component, namely, the QR-based dynamic mapping of the present invention. This is clearly demonstrated with a two-mode design as depicted in FIG. 8A and FIG. 8B. For simplicity, only one motion control is described. The prior art two-mode design as depicted in FIG. 8A comprises four components, (a) a motion control 20; (b) a mode-selection means 30; (c) a static mapping 50a for the first mode; and (d) another static mapping 50b for the second mode. In contrast, the present invention as depicted in FIG. 8B comprises (a) a motion control 20; (b) a mode-selection means 30; (c) a static mapping 50a for the first mode; and (d′) a QR-based dynamic mapping 60 (a different/new component) for the second mode. Note that the mode-selection means in FIG. 8A and FIG. 8B represents logical switch rather than physical switch.

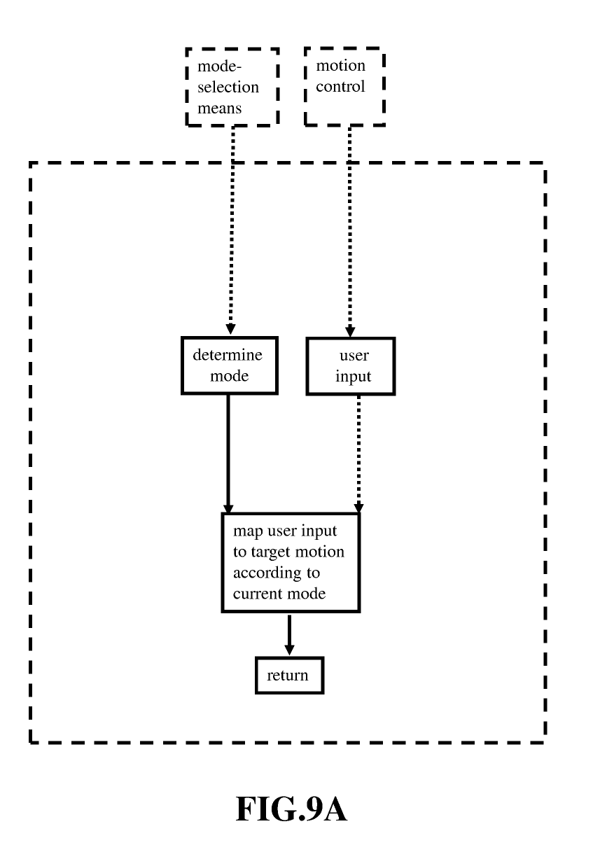

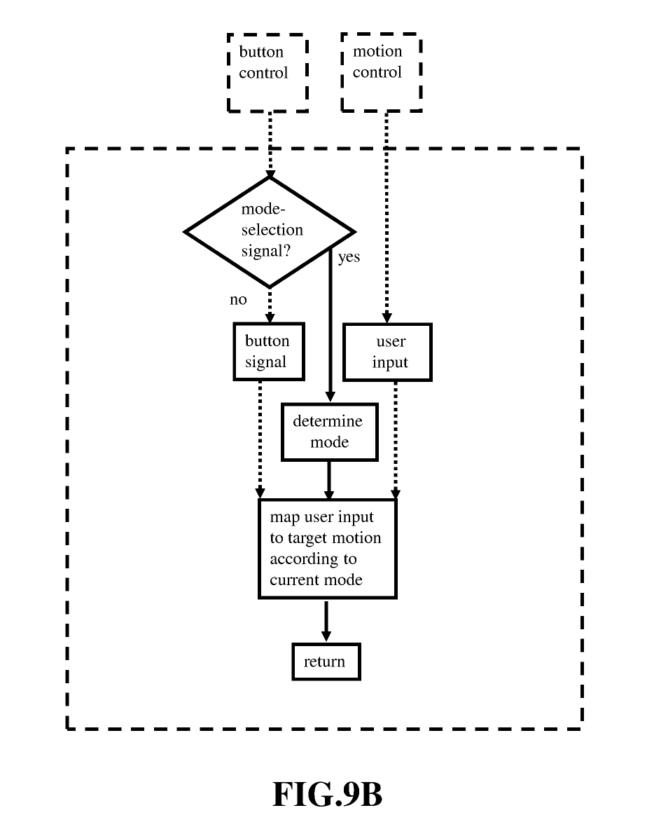

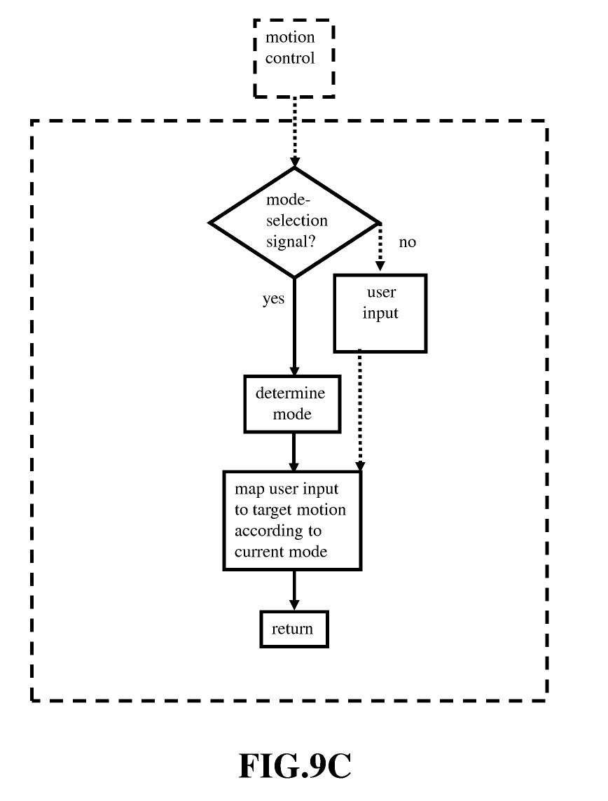

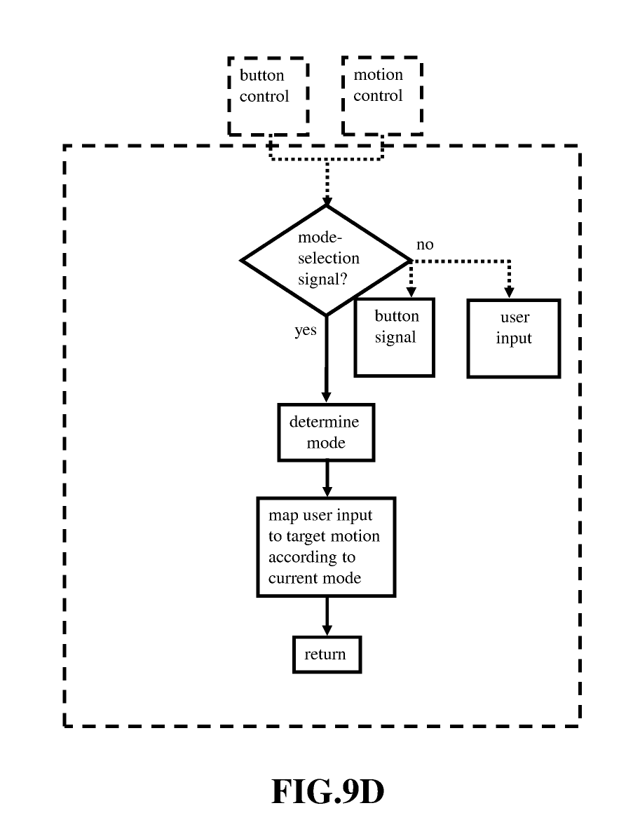

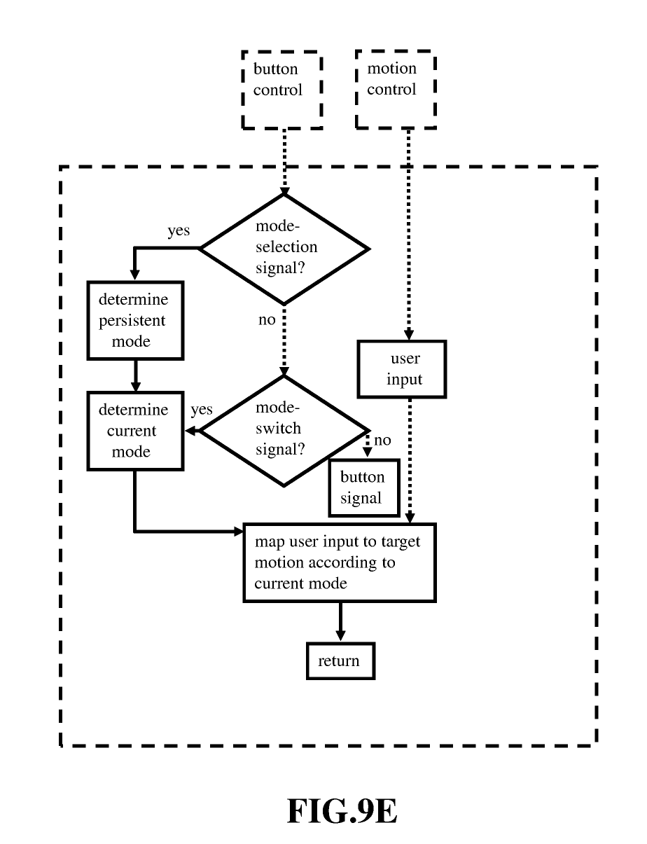

FIG. 9A shows the operation of an exemplary embodiment of the third aspect of the present invention where a dedicated mode-selection means is used. Although momentary modes may be used, persistent modes are preferred. The signals from the mode-selection means are used for mode-selection requests, while that the motion-control signals (from the motion control) generate the user inputs. For simplicity, only one motion control is described here. When a mode-selection request is received, the mode changes accordingly. For different modes, different mappings (static mapping, dynamic mapping, or QR-based dynamic mapping) may be used.

FIG. 9B shows the operation of another exemplary embodiment of the third aspect of the present invention, where a button control doubles as the mode-selection means. The button-control signals are tested to determine whether they indicate a mode-selection request. If so, the mode changes accordingly and the button-control signals may be passed on or modified. Otherwise, the button-control signals are passed on as normal signals.

FIG. 9C shows the operation of yet another embodiment of the third aspect of the present invention, where the motion control doubles as the mode-selection means. The motion-control signals are tested to determine whether they indicate a mode-selection request. If so, the mode changes accordingly and the motion-control signals may be passed on or modified. Otherwise, the motion-control signals are passed on as normal signals.

FIG. 9D shows the operation of yet another embodiment of the third aspect of the present invention, where a button control and a motion control jointly double as the mode-selection means. The button-control signals and the motion-control signal are tested jointly to determine whether they indicate a mode-selection request. If so, the mode changes accordingly and these control signals may be passed on or modified. Otherwise, these control signals are passed on as normal control signals.

Yet another embodiment of the third aspect of the present invention uses a mode-selection menu. The button-control signals and motion-control signals are tested to determine if a left button down occurs when the cursor is on a selectable item of the mode-selection menu. If so, the mode changes accordingly.

To describe the user operation, let us consider a simple two-mode mouse where in the first mode the mouse motion control controls cursor motion and in the second mode it controls document scroll. To be specific, this example uses the mode-selection means comprising a momentary switch as described in the first aspect of the present invention, conventional static mapping is used in the cursor mode and the QR-based dynamic mapping is used in the scroll mode. In particular, the QR-based dynamic mapping as described in FIG. 5C is adopted. This specific embodiment is for illustration only and should not be construed in any way as limitations of the present invention.

The operation of the cursor mode is identical to that of a conventional mouse, where conventional static mapping is adequate and familiar. When the user clicks the mode-selection means (momentary switch), the pointing device changes to the scroll mode. The user can adjust the scroll velocity (direction and magnitude) continuously by moving the mouse (adjusting the displacement). When desired velocity is achieved, the user can continue the scroll by simply leaving the mouse in its current position. This is particularly useful for large amount of scroll, for example, through a long document while reading. The user can stop the scroll by moving the mouse in the substantially reversed direction of the current scroll with a sufficient amount to clear the stop threshold.

The scroll control described above is much effective and efficient than any of the existing and proposed scroll techniques, such as scroll bar, scroll wheel, scroll ball (trackball), scroll stick (joystick), dual-mode designs, host-implemented methods, prior art dynamic mappings, etc. In fact, if both modes used static mapping, as suggested by most of the prior art dual-mode designs, the scroll control would be ineffective and/or inefficient. The two buttons may also be re-assigned to other functions in the scroll mode, for example, the forward and backward browser buttons. The user can change back to the cursor mode by clicking the mode-selection means again.

The mixed-mode design of the first aspect of the present invention may also be used with the QR-based dynamic mapping. Any of the exemplary embodiments depicted in FIG. 2B to FIG. 2F may be used. One example based on the embodiment depicted in FIG. 2F will be described, where the existing right button control doubles as both the mode-selection means and the mode-switch means. The operation of the embodiment is depicted in FIG. 9E (left button is not shown and described). The button-control signals of the right button control are first tested to determine if they represent a specific mode-selection request. If so, the system determines the persistent mode according to the mode-selection request. The system then determines the current mode, which is either the persistent mode or the corresponding momentary mode, according to the state of the mode-switch means. Otherwise, the system further test the button-control signals to determine if the mode-switch means changes state. If so, the system determines the current mode. If the button-control signals do not represent any mode-selection request or indicate the change of state of the mode-switch means, they are passed on as normal button-control signals. The system always maps the user inputs to the corresponding target motion according to the current mode.

To describe the user operation, consider a design with two persistent modes, namely, the cursor mode and scroll mode. The persistent cursor mode has a momentary scroll mode, while the persistent scroll mode has a momentary cursor mode. This mixed-mode design allows a user to momentarily switch to the momentary scroll mode from the persistent cursor mode for small amount and occasional scrolls, or conversely, from persistent scroll mode to momentary cursor mode for occasional cursor motion and item selection.

The start/stop/re-center control may also be provided by the mode-selection means or the mode-switch means, so the tasks required for start/stop/re-center (setting TMOn flag, resetting the collection of qualified user inputs, etc.) are performed when the pointing device enters/exits from a persistent and/or momentary mode. This set of the start/stop/re-center control will start/stop/re-center all target motions/motion controls. It may be the only set of start/stop/re-center control or additional to that provided by a motion control.

### Conclusions, Ramifications, and Scope

The first aspect of the present invention includes an N-persistent-mode pointing device and a 2N-mixed-mode pointing device. The mode-selection means (for persistent modes) is implemented with a momentary switch (mechanical or sensor switch), which allows practically any desired number of persistent modes. The fundamental idea of the present invention is to use a predetermined protocol where a unique sequence of the signals from the two-state switch during a predetermined period of time indicates a specific mode-selection request. The N-persistent-mode design of the present invention overcomes all disadvantages of the prior art single-mode, dual-mode designs, dominant-axis designs, and host-implemented methods, as listed in (A1) to (C5), and (G1) to (G5). The 2N-mixed mode design further improves on the multi-mode designs with persistent modes. This design adds a momentary mode to each persistent mode. A mode-switch means allows a user to switch to the momentary mode. The mode-switch means may comprise a dedicated mechanical switch, a dedicated sensor switch, doubled by the mode-selection means, or doubled by at least one of the existing controls (button or motion control). The 2N-mixed-mode design expands the total modes to 2N and provides more flexibilities and possibilities.

The second aspect of the present invention is an unconventional method for generating target-motion signals with common motion controls used in pointing devices. The fundamental idea of the second aspect of the present invention is the QR-based dynamic mapping where the target motion depends on the user inputs that have predetermined properties (qualified user inputs), regardless of the number of them and/or their relative time positions. The second aspect of the present invention overcomes all disadvantages of the prior art static mappings and dynamic mappings, as listed in (D1) to (F4) and (H1) to (J2).

The third aspect of the present invention combines the multi-mode designs with the QR-based dynamic mapping of the present invention. The fundamental idea of the third aspect of the present invention is to use the optimal mapping method for each pair of motion control and motion function. The third aspect of the present invention solves the problem of incompatible motion functions. The result is that not only each motion control may control multiple motion functions but also each motion function is controlled most effectively and efficiently. This aspect of the present invention overcomes all disadvantages of the prior art designs, as listed in (A1) to (J2).

The skilled in the art should appreciate that all the exemplary embodiments, figures, and operation flow charts are for illustration only. They do not necessarily represent the best/optimal implementations, working modes, or algorithms of the present invention, and should not be construed in any way as limitations of the present invention. Although it has been attempted to include as many as possible embodiments and examples, there are countless other embodiments, combinations, variations, and modifications. These embodiments, combinations, variations, and modifications are readily apparent to the skilled in the art based on the fundamental idea and the spirit of the present invention. The following claims are intended to define the scope of the present invention.

What is claimed is:

1. A method for controlling a plurality of functions of a computer, comprising the steps of:
(a) providing a predetermined number of user-operable controls that generate control signals reflecting user operations,
(b) providing a correspondence with a predetermined number of persistent modes, said correspondence associating each said control to a said function in each said persistent mode,
(c) providing a mode-selection means comprising at least one momentary switch that generates a first signal when activated and a second signal when deactivated,
(d) providing a mode-selection protocol where a predetermined unique sequence of said first signal and second signal within a predetermined period of time indicates a specific mode-selection request,
(e) using said mode-selection means to indicate a selected mode from all said persistent modes according to said mode-selection protocol,
(f) using said control signals of each said control to its associated said function in each said persistent mode according to a predetermined mapping,
whereby a momentary switch can indicate practically any desired number of said persistent modes, whereby each said control may control multiple said functions, and whereby increasing the number of said functions does not require additional controls, whereby a user only needs to operate said momentary switch when changing said persistent mode.

2. The method of claim 1 wherein said persistent modes include a default persistent mode, said default persistent mode being assumed when predetermined condition occurs.

3. The method of claim 1 wherein
(a) a momentary mode is further added to each said persistent mode, in said momentary mode each said control may control another said function,
(b) a user-operable mode-switch means that is capable of generating a momentary signal is further provided to allow user to momentarily switch from any said persistent mode to the corresponding said momentary mode,
(c) the hardware component of said mode-switch means is of a type selected from the group consisting of a dedicated momentary mechanical switch, a dedicated momentary sensor switch, doubled by said mode-selection means, doubled by at least one of said user-operable controls,
whereby up to twice as many functions can be controlled.

4. A method for generating control signals to control at least one predetermined target motion of a computer, comprising:
(a) providing a user operable motion control that generates user inputs reflecting user operations;
(b) choosing a suitable qualification rule;
(c) selecting qualified user inputs from all said user inputs according to said qualification rule;
(d) choosing at least one suitable source quantity that is derivable from said qualified user inputs and a time reference;
(e) choosing at least one suitable target quantity that is sufficient for updating said target motion;
(f) using a suitable transformation function to transform said source quantity to said target quantity,
(g) generating motion-control signals for updating said target motion based on said target quantity;
whereby said method employs a qualification-rule-based dynamic mapping that maps said target motion to all qualified user inputs, and whereby said target motion can be controlled effectively and efficiently by said user.

5. The method in claim 4 wherein said qualified user inputs include all user inputs that have occurred.

6. The method of claim 4 wherein said qualified user inputs are those whose magnitudes exceed said predetermined threshold, said source quantity is the vector sum of said qualified user inputs, and said target quantity is the velocity of said target motion.

7. The method of claim 4 wherein said qualified user inputs are a predetermined number of the most recent user inputs whose magnitudes exceed a predetermined threshold.

8. The method of claim 4 wherein said source quantity is a predetermined combination involving at least one of the time-derivative of said qualified user inputs of predetermined order.

9. The method of claim 4 wherein said target quantity is a predetermined combination involving at least one quantity selected from the group consisting of increment, velocity, acceleration, and predetermined order of time-derivatives of said target motion.

10. The method of claim 4 wherein a predetermined control protocol is further added, said control protocol using at least one unique pattern of said user inputs that indicating at least one type of control requests selected from the group consisting of starting said target motion, stopping said target motion, and re-centering said motion control.

11. The method of claim 4 wherein a predetermined mapping-alteration protocol is further added, said control protocol using at least one unique pattern of said user inputs that indicating a predetermined alteration on at least one of the aspects selected from the group consisting of said qualification rule, said source quantity, said target quantity, and said transformation function.

12. A multi-mode pointing device for controlling a plurality of predetermined functions of a computer, comprising:
(a) at least one button control that produces a first button-control signal when activated and a second button-control signal when deactivated,
(b) at least one motion control that detects certain types of motion caused by a user and generates motion-control signals accordingly,
(c) a mode-selection means that allows a user to indicate a selected mode from a predetermined number of modes,
(d) for each said mode said motion-control signals are used to control a predetermined said function using a predetermined mapping,
(e) at least one of said mappings is a qualification-rule-based dynamic mapping which maps all said motion-control signals that satisfy a predetermined qualification rule to said function,
whereby a user can use said motion control to control a plurality of said target motion, whereby said motion control may employ different type of mapping in different mode, and whereby each said target motion is controlled effectively and efficiently by the same motion control.

13. The multi-mode pointing device of claim 12 wherein at least one of said function is a motion function, said qualification-rule-based dynamic mapping maps the sum of the motion-control signals whose magnitudes exceed a predetermined threshold to the velocity of said motion function.

14. The multi-mode pointing device of claim 12 wherein at least one of said function is a motion function, said motion function stops when said mode changes.

15. The multi-mode pointing device of claim 12 wherein
(a) all said modes are persistent modes,
(b) a momentary mode is further added to each said persistent mode, in said momentary mode each said control may control another said function,
(c) a user-operable mode-switch means that is capable of generating a momentary signal is further provided to allow user to momentarily switch from any said persistent mode to the corresponding said momentary mode,
(d) the hardware component of said mode-switch means is of a type selected from the group consisting of a dedicated momentary mechanical switch, a dedicated momentary sensor switch, doubled by said mode-selection means, doubled by at least one of said user-operable controls.

16. The multi-mode pointing device of claim 12 wherein said mode-selection means comprising a dedicated user-operable control that is capable of generating signals indicating mode-selection requests.

17. The multi-mode pointing device of claim 12 wherein said mode-selection means comprising a momentary switch that is capable of generating a first signal when activated and a second signal otherwise, a predetermined unique sequence of said first and second signals indicating a specific mode-selection request.

18. The multi-mode pointing device of claim 12 wherein said mode-selection means is doubled by said button control, a predetermined unique sequence of said button-control signals indicating a specific mode-selection request.

19. The multi-mode pointing device of claim 12 wherein mode-selection means is doubled by said motion control, a predetermined unique pattern of said motion-control signals indicating a specific mode-selection request.

20. The multi-mode pointing device of claim 12 wherein mode-selection means is doubled by said button control and said motion control, a predetermined unique combination of said button-control signals and said motion-control signals indicates a specific mode-selection request.
